(19) United States
(12) Patent Application Publication
(10) Pub. No.: US 2020/0182324 A1
(43) Pub. Date: Jun. 11, 2020

(54) VEHICLE WEIGHT MEASUREMENT DEVICE

(71) Applicant: NSK LTD., Tokyo (JP)

(72) Inventors: Eisaku SUZUKI, Fujisawa-shi, Kanagawa (JP); Masafumi HIKIDA, Fujisawa-shi, Kanagawa (JP); Yasuyuki MATSUDA, Fujisawa-shi, Kanagawa (JP); Yosuke SHIMOMURA, Fujisawa-shi, Kanagawa (JP)

(73) Assignee: NSK LTD., Tokyo (JP)

(21) Appl. No.: 16/617,683

(22) PCT Filed: Oct. 30, 2018
(86) PCT No.: PCT/JP2018/040412

§ 371 Date: Nov. 27, 2019

(30) Foreign Application Priority Data
Nov. 24, 2017 (JP) 2017-225502
Dec. 1, 2017 (JP) 2017-231570
May 22, 2018 (JP) 2018-097767

(51) Int. Cl. F16F 9/54; B60G 17/019; G01G 19/10; B60G 15/07

(52) U.S. Cl. CPC F16F 9/54; B60G 15/07; G01G 19/10; B60G 17/019

(57) ABSTRACT

A vehicle weight measurement device includes a moving body, an attachment body, a stopper ring provided between the moving body and the attachment body, and a rotation prevention part configured to prevent the moving body and the attachment body from rotating relative to each other. The stopper ring includes a fixing part fixed to one of the moving body and the attachment body and a separation and detachment prevention part provided at the other of the moving body and the attachment body and configured to prevent the moving body and the attachment body from separating and detaching, without inhibiting movement of the moving body. The rotation prevention part includes a pin fitted from the moving body to the attachment body.

### TECHNICAL FIELD

The present invention relates to a device configured to measure a weight of a vehicle, for example, a vehicle weight measurement device incorporated into a suspension of an automobile and configured to detect overloading.

### BACKGROUND ART

Illegal overloading of automobiles, particularly, commercial cars such as trucks and vans for transporting a variety of cargoes, which pass a road with exceeding a mandatory load capacity, become a social problem. The reason is that it is possible to save the transportation cost by transporting a lot of cargoes at one time.

However, the overloading should be avoided because it may cause diverse problems, as follows.

(1) Since motion performance of the automobile may be lowered or a constitutional component may be broken due to the overloading, the overloading may be a cause of an accident. For example, the overloading has many factors that may cause accidents and the like, such as breakage of an axle (hub), breakage (burst) of a tire, a lengthened braking distance and malfunction of a brake due to overheating, and a tendency of a vehicle to be overturned.

(2) Since the overloading causes severe road damage, road maintenance cost increases.

It is difficult to prevent the overloading due to many causes. One of the causes is that a driver or a passenger cannot easily perceive a loaded weight. That is, in the related art, a load (loaded weight) of the vehicle is measured by putting the vehicle, which is a measurement target, on a platform scale.

However, the installation of the platform scale requires a large facility and a wide installation space, which increase installation cost. Therefore, the number of the platform scales to be installed is limited, so that it is physically difficult to measure many vehicles.

Therefore, as disclosed in Patent Document 1 and the like, a simple load measurement device mounted to the vehicle itself and capable of measuring load is recently suggested.

For example, the technology disclosed in Patent Document 1 is a simple load measurement device configured to measure load by detecting compression strain. The load measurement device includes a base assembly, a sensor element for compression strain detection, and a circuit board. The base assembly is melted at two melting parts to different attachment places of a loaded member configured to be expanded and contracted as load of the vehicle is applied thereto. The sensor element for compression strain detection is supported by the base assembly and an output thereof changes as the base assembly is expanded and contracted in directions in which the two melting parts are approached and separated due to a change in load applied to the vehicle. On the circuit board, an amplifier configured to amplify the output of the sensor element for compression strain detection is mounted.

However, in the above kind of the weight measurement device, since the configuration is complex and it is necessary to provide the circuit board, the amplifier and the like, as disclosed in Patent Document 1, the cost increases. Also, since the weight measurement devices are provided at places that are susceptible to shock, problems may be caused in the circuit board, the amplifier and the like.

Therefore, the inventors of the subject application succeeded in solving the above-described problems by providing a simple, inexpensive and highly durable vehicle weight measurement device capable of measuring compressive load to be applied to a suspension, focusing on a bearing device incorporated into the suspension in the vicinity of an attachment part to a vehicle body (Patent Document 2).

Specifically, the suspension is provided integrally with the weight measurement device of Patent Document 2. A piston is axially guided with being in sliding contact with a collar by a coil spring of the suspension. A diaphragm is pressed to apply a pressure to a measurement fluid filled in an oil chamber, and a pressure change is detected by a pressure sensor.

### CITATION LIST

### Patent Literature

Patent Document 1: JP-A-2001-330503

Patent Document 2: JP-A-2017-227634

### SUMMARY OF INVENTION

### Technical Problem

The weight measurement device disclosed in Patent Document 2 is largely configured by two functional blocks.

The first function block is a load detection part (attachment body) which is to be fixed to a vehicle and which includes a hydraulic chamber (oil chamber) in which a measurement fluid (operating oil) is filled, a diaphragm by which a part of the oil chamber is configured to be press-deformable, and a pressure sensor provided in communication with the oil chamber and configured to detect a pressure change in the oil chamber as a result of pressing the diaphragm.

The second functional block is a piston part (moving body) configured to move and to thereby press the diaphragm in accordance with the load by resilient force of a spring, and the like.

A main target of the above kind of the weight measurement device is a small-sized commercial car.

In many cases, for the small-sized commercial car, strut-type or double wishbone-type front wheels are used, and trailing arm-type, semi-trailing arm-type or torsion beam-type rear wheels are used.

Also, in a case in which the diaphragm and the pressure sensor are incorporated into a suspension for rear wheels, they are attached to a bottom plate, and in a case in which the diaphragm and the pressure sensor are incorporated into a suspension for front wheels, they are attached to a top plate,

In the case of the weight measurement device including the attachment body and the moving body, like Patent Document 2, after installed to the vehicle, the weight measurement device is axially applied with extension force of the coil spring and is pressed to an arm, so that the attachment body and the moving body are not separated and detached from each other. However, before installed to the vehicle, the attachment body and the moving body may be separated and detached from each other, which is unfavorable for transportation and the like to automobile assembly factories.

Also, in the state in which the weight measurement device is installed to the vehicle, the attachment body and the moving body may rotate relative to each other. Therefore, wears of the diaphragm and the piston may be promoted due to the rotation.

Therefore, as described above, Patent Document 2 is to provide the simple, inexpensive and highly durable vehicle weight measurement device, to prevent the attachment body and the moving body from separating and detaching, and to prevent the attachment body and the moving body from rotating relative to each other,

That is, in the configuration disclosed in Patent Document 2, a stopper ring having a notched part provided at a part thereof is bolt-fastened to an outer peripheral part of the piston configuring the moving body, and the notched part of the bolt-fastened stopper ring is fitted to a protrusion provided on a part of an outer peripheral part of the bottom plate configuring the attachment body. Thereby, the moving body (piston) and the attachment body (bottom plate) are prevented from rotating relative to each other and from separating and detaching.

However, in the configuration disclosed in Patent Document 2, it is necessary to provide the protrusion, which is to fit with the notched part of the stopper ring, on the outer peripheral part of the piston. Therefore, a shape of the piston is complicated and the molding and product costs are increased.

Also, since the weight measurement device configured as described above is arranged in combination with the suspension of the vehicle, in particular, the coil spring and a shock absorber, it is assumed that the weight measurement device is used under severe environments exposed to muddy water, dust and the like.

Particularly, in the case of rear wheels, since the oil chamber is provided to the bottom plate (attachment body) and the bottom plate is attached to the arm, the weight measurement device is always in a state in which it is close to a ground.

In the case of the above weight measurement device, the load from the coil spring and the like is applied to the diaphragm, and the pressure change in the oil chamber is detected by the sensor. Therefore, it is necessary to secure a space for enabling the moving body to move between facing surfaces of the attachment body and the moving body. For this reason, a movement allowing gap for allowing the moving body to move is formed between the facing surfaces of the attachment body and the moving body.

However, when foreign matters such as muddy water, dust/gravel and the like are introduced into the movement allowing gap, the foreign matters such as dust, gravel and the like are stuck in the gap, so that movement of the moving body in a vertical direction is obstructed and a weight may not be correctly measured.

Also, a recess is formed in a sliding area of the collar configuring the attachment body and the piston configuring the moving body, and the muddy water, dust and the like introduced in the recess are not discharged. For this reason, the muddy water and the like are stagnant in the recess and rust, corrosion and the like are thus incurred, so that strength reduction, function deficiency and the like may be caused.

Also, for example, in the case of the weight measurement device for front wheels, it is necessary to apply the load from the spring and the like to the diaphragm of the attachment body (load detection part). To this end, it is necessary to secure movement of the piston configuring the moving body (piston part), so that a gap is formed between the collar configuring the attachment body and the piston configuring the moving body.

Since the above kind of the weight measurement device is provided in a position close to a road surface, it is likely to be exposed to environments in contact with water, waste/gravel and the like.

As described above, since the gap is formed between the attachment body (load detection part) and the moving body (piston part), water, waste/gravel and the like are likely to be introduced from the gap between the attachment body (load detection part) and the moving body (piston part) and are difficult to be discharged. When water and the like are stagnant, rust, corrosion and the like are incurred, so that strength reduction and function deficiency may be caused.

Also, since the vehicle weight measurement device of the present invention is used in a variety of fields, for example, a field of overloading prevention, a field of improving environmental performance (saving fuel consumption) by performing speed change control in accordance with a loaded weight, depending on a movable load, a field of improving safety by performing brake control, considering a weight distribution, a field of improving comfortableness by performing control of keeping a steering environment constant, and the like, the above problem is one of important problems to be solved.

The present invention has been made in view of the above problems, and an object thereof is to provide a vehicle weight measurement device capable of preventing an attachment body and a moving body from separating and detaching and rotating relative to each other while simplifying a piston shape.

Also, an object of the present invention is to prevent introduction of foreign matters from a movement allowing gap of the moving body inevitably formed between the attachment body and the moving body.

Also, an object of the present invention is to provide a vehicle weight measurement device capable of preventing introduction of foreign matters such as water from a space between the attachment body and the moving body.

### Solution to Problem

In order to achieve the above objects, a first present invention provides a vehicle weight measurement device including:

a moving body configured to move by resilient force of a spring;

an attachment body including at least:
a diaphragm configured to be press-deformable by a movement of the moving body;
an oil chamber having a predetermined measurement fluid filled therein and an internal pressure capable of changing as a result of pressing the diaphragm and;
a pressure sensor capable of detecting a pressure change in the oil chamber;

a stopper ring provided between the moving body and the attachment body; and

a rotation prevention part configured to prevent the moving body and the attachment body from rotating relative to each other;

wherein the stopper ring includes:
a fixing part fixed to one of the moving body and the attachment body; and
a separation and detachment prevention part provided at the other of the moving body and the attachment body and configured to prevent the moving body and the attachment body from separating and detaching, without inhibiting movement of the moving body, and

wherein the rotation prevention part includes a pin fitted from the moving body to the attachment body.

In the vehicle weight measurement device of a second present invention according to the first present invention, the attachment body includes a bottom plate having a lower surface to be in contact with an arm of a suspension upon installation, an opened upper surface and a groove part of which an opening region is covered by the diaphragm to thereby form the oil chamber, and

the moving body includes a piston provided to be movable in a longitudinal direction of the suspension and capable of pressing the diaphragm by resilient force of a spring of the suspension.

In the vehicle weight measurement device of a third present invention according to the second present invention, the stopper ring includes:
a cylindrical part configured to cover outer peripheries of the bottom plate and the piston; and
a circular ring part formed to have an inner diameter smaller than an outer diameter of the bottom plate by a lower surface of the cylindrical part,

a part of the cylindrical part is press-fitted and fixed to the outer periphery of the piston and thus functions as the fixing part,

the circular ring part is engaged by the lower surface of the bottom plate without inhibiting movement of the moving body and thus functions as the separation and detachment prevention part configured to prevent the moving body and the attachment body from separating and detaching, and

the rotation prevention part is configured by a first fitting hole provided in the piston, a first notched groove provided in the bottom plate, and a pin capable of being fitted from the first fitting hole to the first notched groove.

In the vehicle weight measurement device of a fourth present invention according to the second present invention, the stopper ring includes:
a cylindrical part configured to cover outer peripheries of the bottom plate and the piston; and
a circular ring part formed to have an inner diameter smaller than an outer diameter of the bottom plate by a lower surface of the cylindrical part,

a part of the cylindrical part is press-fitted and fixed to the outer periphery of the piston and thus functions as the fixing part,

the circular ring part is engaged by the lower surface of the bottom plate without inhibiting movement of the moving body and thus functions as the separation and detachment prevention part configured to prevent the moving body and the attachment body from separating and detaching, and

the rotation prevention part is configured by a second notched groove provided in the piston, a second fitting hole provided in the bottom plate, and a pin capable of being fitted from the second notched groove to the second fitting hole.

A fifth present invention provides a vehicle weight measurement device including:

a moving body configured to move by resilient force of a spring;

an attachment body including at least:
a diaphragm configured to be press-deformable by a movement of the moving body;
an oil chamber having a predetermined measurement fluid filled therein; and
an internal pressure capable of changing as a result of pressing the diaphragm, and a pressure sensor capable of detecting a pressure change in the oil chamber;

a stopper ring provided between the moving body and the attachment body, and

a rotation prevention part configured to prevent the moving body and the attachment body from rotating relative to each other,

wherein the stopper ring includes a fixing part fixed to one of the moving body and the attachment body and a separation and detachment prevention part provided at the other of the moving body and the attachment body and configured to prevent the moving body and the attachment body from separating and detaching, without inhibiting movement of the moving body, and

wherein the rotation prevention part includes a pin fitted from one of the moving body and the attachment body, to which the fixing part of the stopper ring is not fixed, to the stopper ring.

The vehicle weight measurement device of a sixth present invention according to one of the first to fifth present inventions further includes a sealing mechanism configured to prevent foreign matters from being introduced into a movement allowing gap formed between facing surfaces of the moving body and the attachment body.

In the vehicle weight measurement device of a seventh present invention according to the sixth present invention, the sealing mechanism is configured by a seal part provided between the stopper ring and the attachment body.

In the vehicle weight measurement device of an eighth present invention according to the seventh present invention, the seal part is provided integrally with the stopper ring and is in sliding contact with the attachment body.

In the vehicle weight measurement device of a ninth present invention according to the seventh present invention, the seal part is provided integrally with the attachment body and is in sliding contact with the stopper ring.

In the vehicle weight measurement device of a tenth present invention according to one of the sixth to ninth present inventions, an elastic plate is provided on an attachment surface-side of the attachment body, and

the sealing mechanism includes a seal part provided on an outer peripheral edge of the elastic plate and being in sliding contact with the stopper ring.

In order to achieve the above objects, an eleventh invention provides a vehicle weight measurement device including:

a moving body configured to move by resilient force of a spring;

an attachment body including at least:
a diaphragm configured to be press-deformable by a movement of the moving body;
an oil chamber having a predetermined measurement fluid filled therein and an internal pressure capable of changing as a result of pressing the diaphragm; and
a pressure sensor capable of detecting a pressure change in the oil chamber, and

a sealing device provided between the moving body and the attachment body.

In the vehicle weight measurement device of a twelfth invention according to the eleventh invention, a surface of the moving body facing the attachment body is provided with a tapered surface having a shape inclined downward from a position of the sealing device.

In the vehicle weight measurement device of a thirteenth invention according to the twelfth invention, the tapered surface is provided with a concave groove having a downwardly inclined shape.

In the vehicle weight measurement device of a fourteenth invention according to one of the eleventh to thirteenth invention, the attachment body includes:

a top plate having an upper surface to be fixed to a vehicle-side, an opened lower surface and a groove part of which an opening region is covered by the diaphragm to thereby form the oil chamber, and

a collar having a diameter larger than the opening region of the groove part and configured to sandwich, seal and fix a surface part close to an outer diameter of the diaphragm between the collar and an outermore surface part than the opening region of the groove part; and

the sealing device is provided between the moving body and the collar.

### Effect of Invention

According to the present invention, it is possible to provide the vehicle weight measurement device capable of preventing the attachment body and the moving body from separating and detaching and rotating relative to each other while simplifying the piston shape. Also, it is possible to prevent introduction of foreign matters from the movement allowing gap of the moving body inevitably formed between the attachment body and the moving body.

Also, according to the present invention, it is possible to provide the vehicle weight measurement device capable of preventing introduction of foreign matters such as water from the space between the attachment body and the moving body.

### BRIEF DESCRIPTION OF DRAWINGS

FIG. 1 is a schematic sectional view depicting a first embodiment.

FIG. 2 is an enlarged view of main parts of the first embodiment.

FIGS. 3A to 3B depict a bottom plate (attachment body) configuring the first embodiment, in which FIG. 3A is a plan view, FIG. 3B is a sectional view taken along a line I-I of FIG. 3A, and FIG. 3C schematically depicts a pin configuring a rotation prevention part.

FIGS. 4A to 4C depict a piston (moving body) configuring the first embodiment, in which FIG. 4A is a plan view, FIG. 4B is a sectional view taken along a line of FIG. 4A, and FIG. 4C is a perspective view schematically depicting the pin configuring the rotation prevention part.

FIG. 5 is an exploded perspective view depicting the first embodiment

FIG. 6 is a schematic sectional view depicting a second embodiment.

FIG. 7 is an enlarged view of main parts of the second embodiment.

FIGS. 8A to 8C depict a bottom plate (attachment body) configuring the second embodiment, in which FIG. 8A is a plan view, FIG. 8B is a sectional view taken along a line III-III of FIG. 8A, and FIG. 8C is a perspective view schematically depicting a pin configuring a rotation prevention part.

FIGS. 9A to 9C depict a piston (moving body) configuring the second embodiment, in which FIG. 9A is a plan view, FIG. 9B is a sectional view taken along a line IV-IV of FIG. 9A, and FIG. 9C is a perspective view schematically depicting the pin configuring the rotation prevention part.

FIG. 10 is a schematic sectional view depicting a third embodiment.

FIG. 11 is an enlarged view of main parts of the third embodiment.

FIGS. 12A to 12C depict a bottom plate (attachment body) configuring the third embodiment, in which FIG. 12A is a plan view, FIG. 12B is a sectional view taken along a line V-V of FIG. 12A, and FIG. 12C is a perspective view schematically depicting a pin configuring a rotation prevention part.

FIGS. 13A to 13C depict a stopper ring configuring the third embodiment, in which FIG. 13A is a plan view, FIG. 13B is a sectional view taken along a line VI-VI of FIG. 13A, and FIG. 13C is a perspective view schematically depicting the pin configuring the rotation prevention part.

FIG. 14 is a schematic perspective view depicting an example in which the present invention is applied to a trailing arm-type suspension.

FIGS. 15A and 15B are schematic sectional views depicting a fourth embodiment, in which FIG. 15A is a schematic entire sectional view depicting a state in which the piston (moving body) and the bottom plate (attachment body) are combined, and FIG. 15B is an enlarged sectional view of main parts.

FIGS. 16A and 16B schematically depict the fourth embodiment, in which FIG. 16A is a plan view and FIG. 16B is a perspective view.

FIGS. 17A to 17C depict a stopper ring of the fourth embodiment, in which FIG. 17A is a schematic plan view, FIG. 17B is a sectional view taken along a line A-A of FIG. 17A and FIG. 17C is a schematic perspective view

FIG. 18 is a perspective view a state in which the vehicle weight measurement device and a coil spring, which is a suspension, are combined in the fourth embodiment.

FIGS. 19A and 19B are schematic sectional views depicting a fifth embodiment, in which FIG. 19A is a schematic entire sectional view depicting a state in which the piston (moving body) and the bottom plate (attachment body) are combined, and FIG. 19B is an enlarged sectional view of main parts.

FIGS. 20A to 20C depicts a bottom plate (attachment body) of the fifth embodiment, in which FIG. 20A is a plan view, FIG. 20B is a sectional view taken along a line A-A of FIG. 20A and FIG. 20C is a schematic perspective view.

FIGS. 21A and 21B are schematic sectional views depicting a sixth embodiment, in which FIG. 21A is a schematic entire sectional view depicting a state in which the piston (moving body) and the bottom plate (attachment body) are combined, and FIG. 21B is an enlarged sectional view of main parts.

FIGS. 22A to 22C depict an elastic plate of the sixth embodiment, in which FIG. 22A is a plan view, FIG. 22B is a sectional view taken along a line A-A of FIG. 22A and FIG. 22C is a schematic perspective view.

FIG. 23A is an enlarged sectional view of main parts of a seventh embodiment, and FIG. 23B is an enlarged sectional view of main parts of an eighth embodiment.

FIG. 24A is an enlarged sectional view of main parts of a ninth embodiment, FIG. 24B is an enlarged sectional view of main parts of a tenth embodiment, and FIG. 24C is an enlarged sectional view of main parts of an eleventh embodiment.

FIG. 25 is a schematic sectional view depicting a twelfth embodiment.

FIGS. 26A to 26C depict a piston configuring a moving body of the twelfth embodiment, in which FIG. 26A is a schematic plan view, FIG. 26B is a sectional view taken along a line I-I of FIG. 26A and. FIG. 26C is a perspective view.

FIG. 27 is a schematic sectional view depicting a thirteenth embodiment.

FIGS. 28A to 28C depict a piston configuring a moving body of the thirteenth embodiment, in which FIG. 28A is a schematic plan view, FIG. 28B is a sectional view taken along a line II-II of FIG. 28A and FIG. 28C is a perspective view.

FIG. 29 is a schematic sectional view depicting a fourteenth embodiment.

FIGS. 30A to 30C depict a piston configuring a moving body of the fourteenth embodiment, in which FIG. 30A is a schematic plan view, FIG. 30B is a sectional view taken along a line III-III of FIG. 30A and FIG. 30C is a perspective view.

### DESCRIPTION OF EMBODIMENT

Hereinbelow, embodiments of the vehicle weight measurement device of the present invention will be described with reference to the drawings.

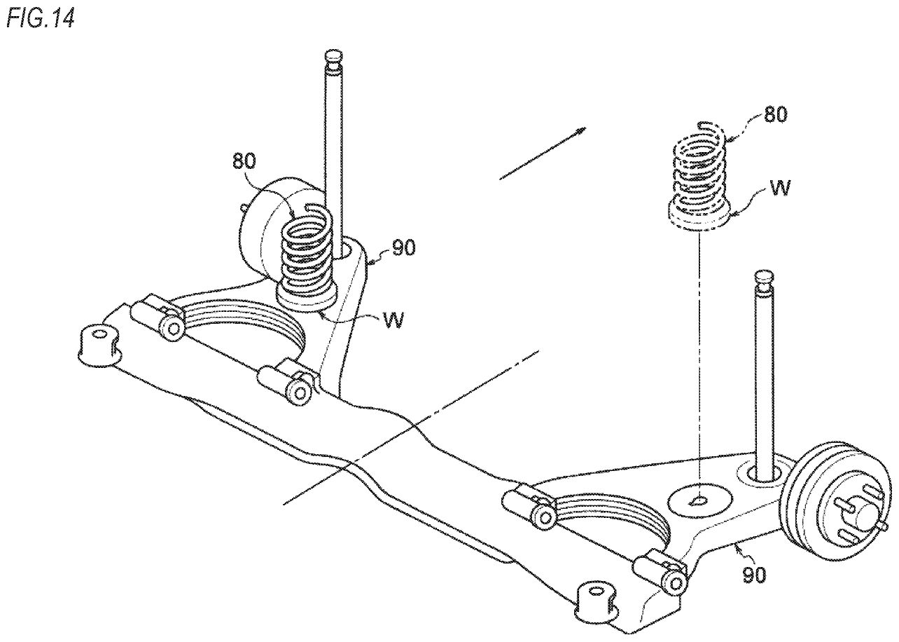

In the embodiments, as an example in which the vehicle weight measurement device of the present invention is used for a suspension of an automobile, an example is described in which the vehicle weight measurement device is applied to a suspension for rear wheels of an automobile, for example, a trailing arm-type suspension for rear wheels of an automobile, as shown in FIG. 14. In the meantime, an arrow in FIG. 14 indicates the rear of a vehicle.

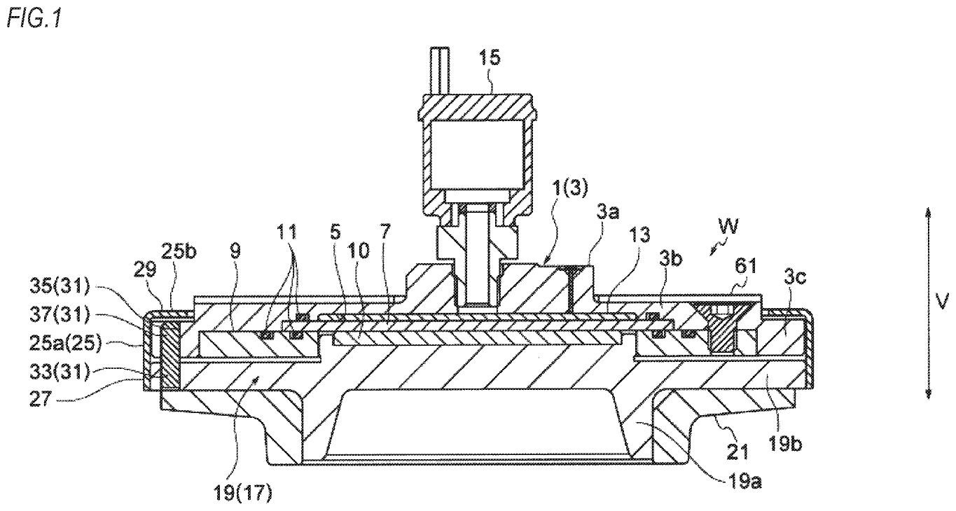

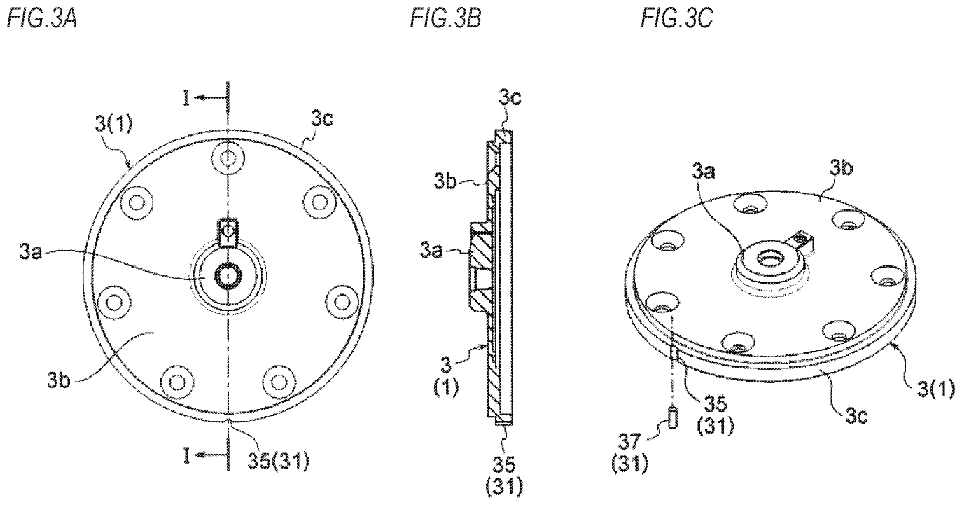

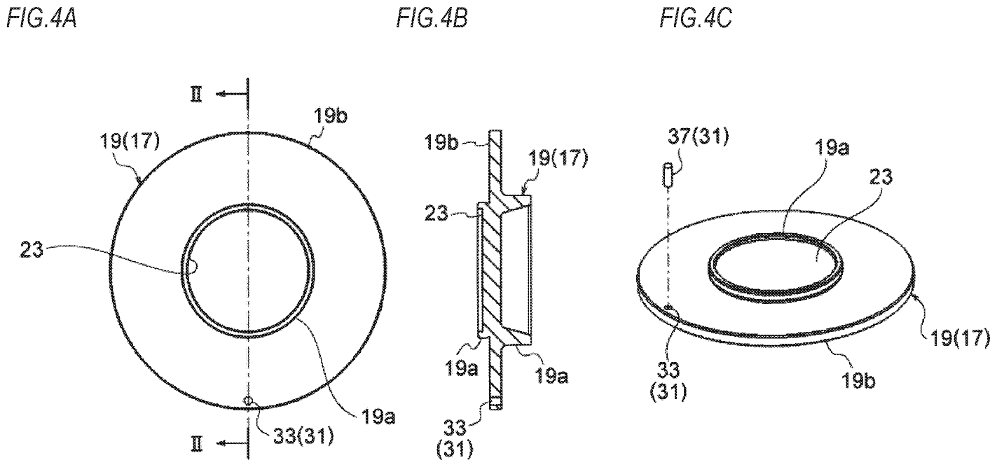

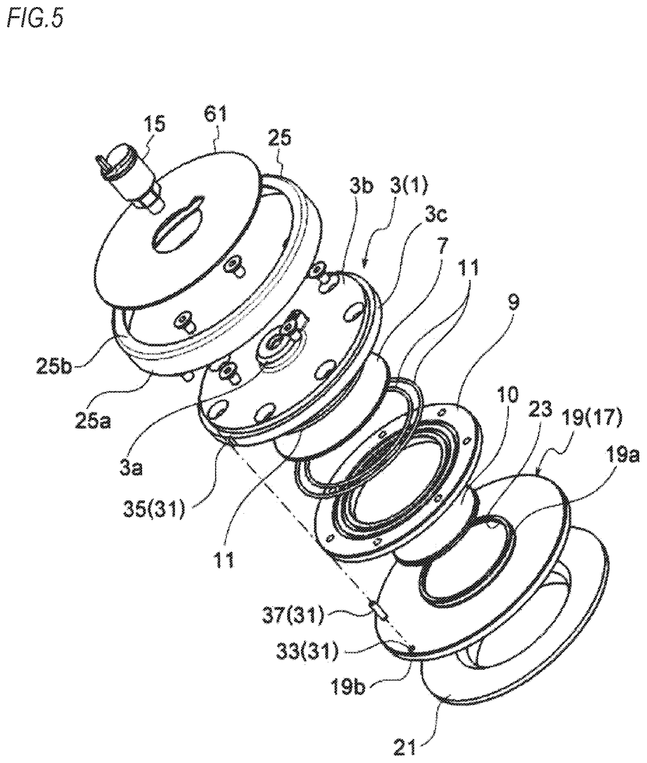

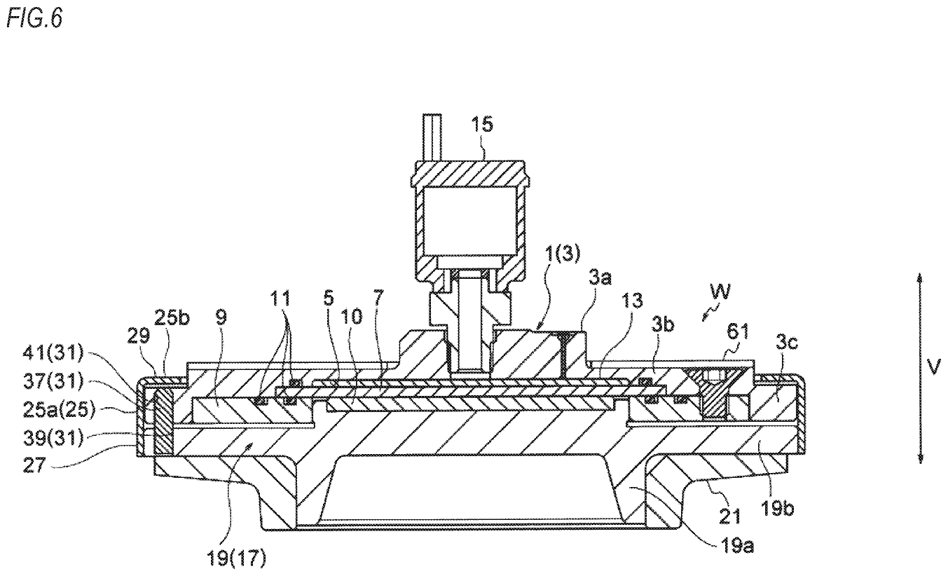

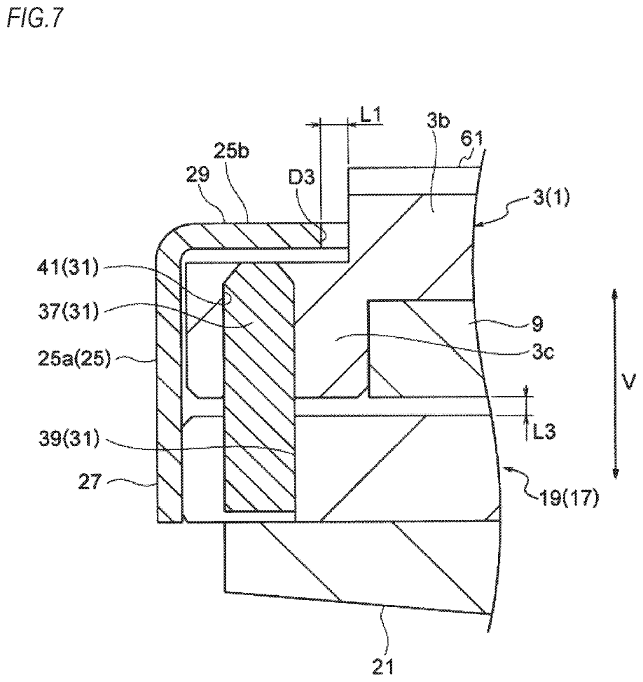

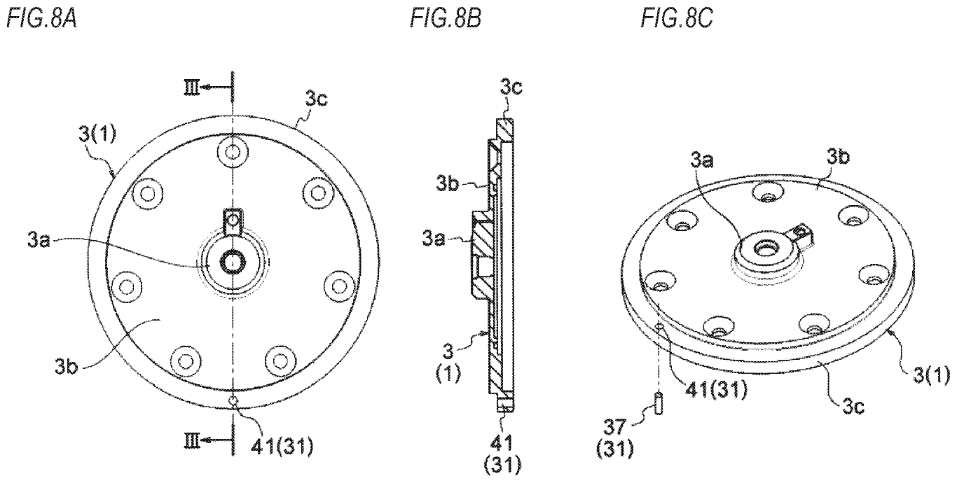

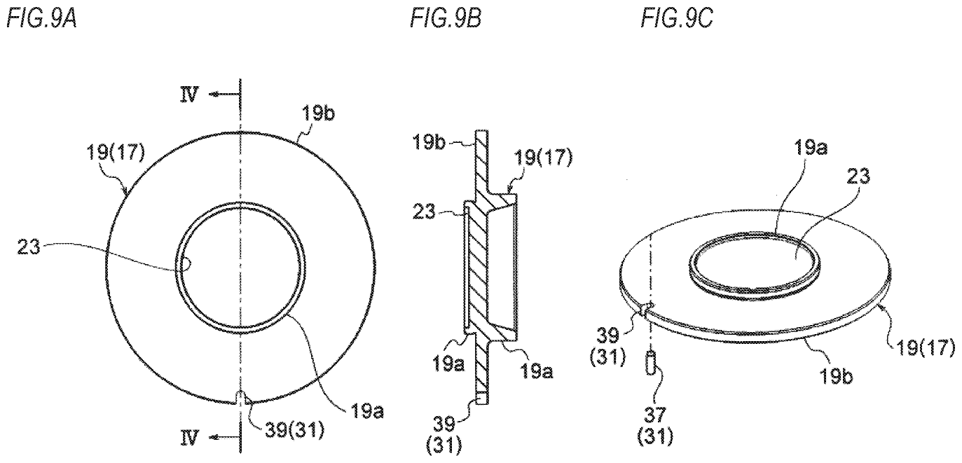

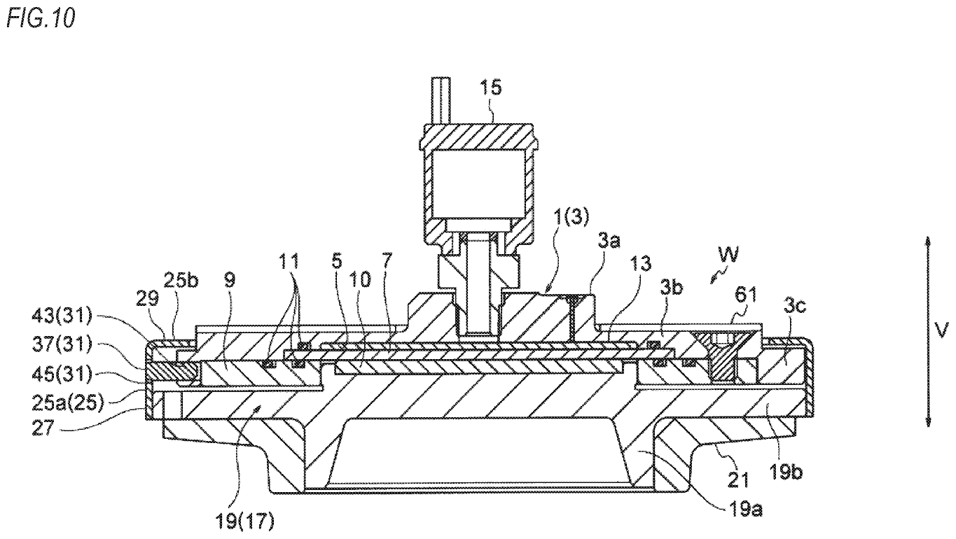

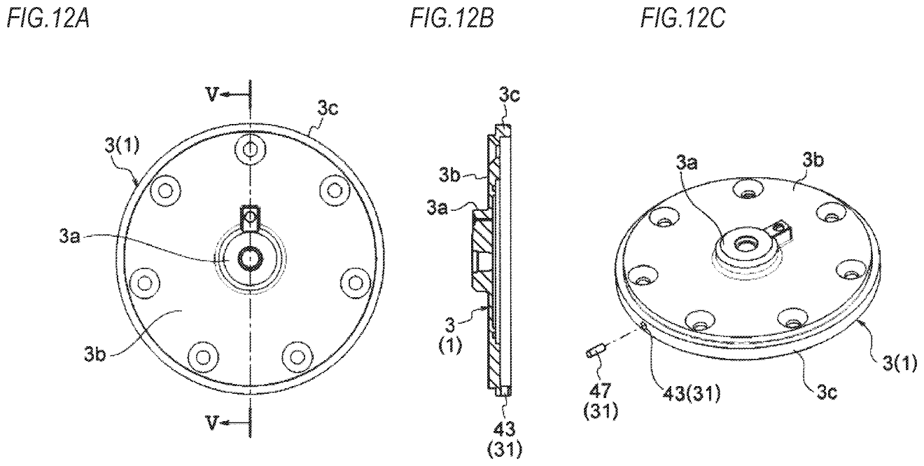

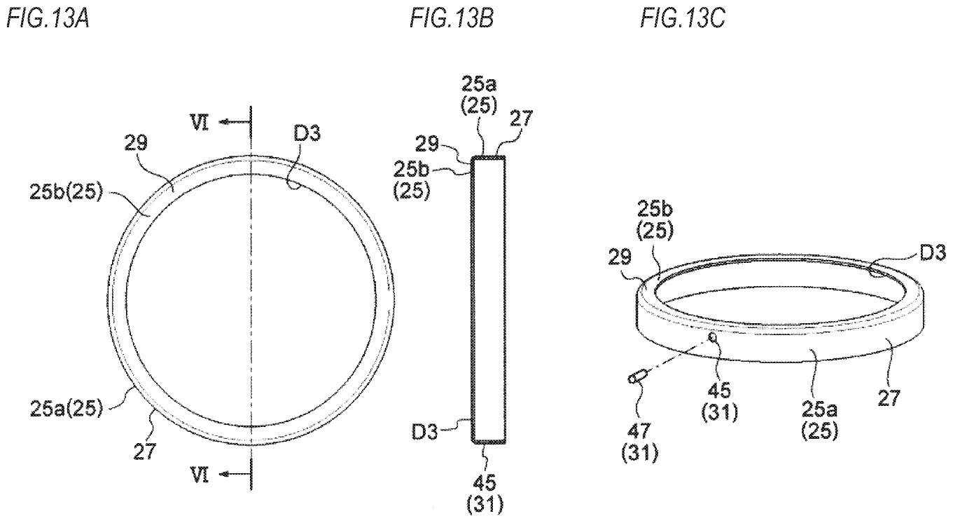

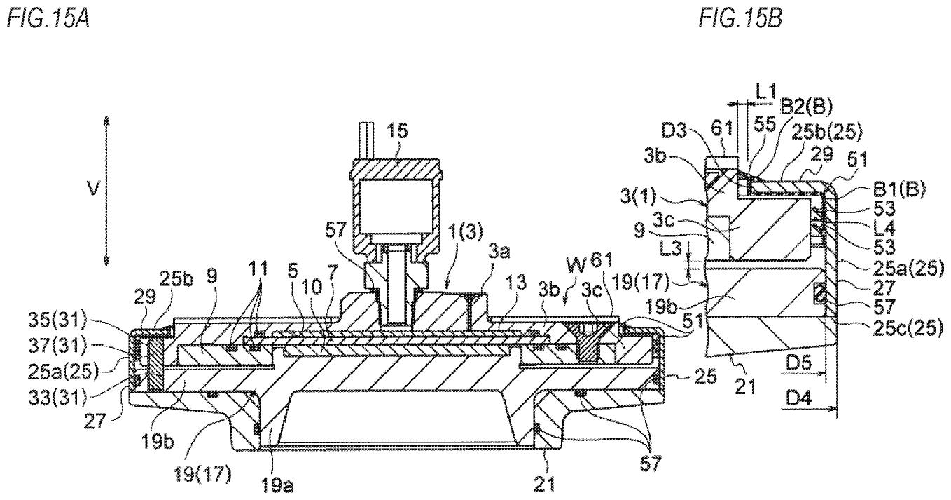

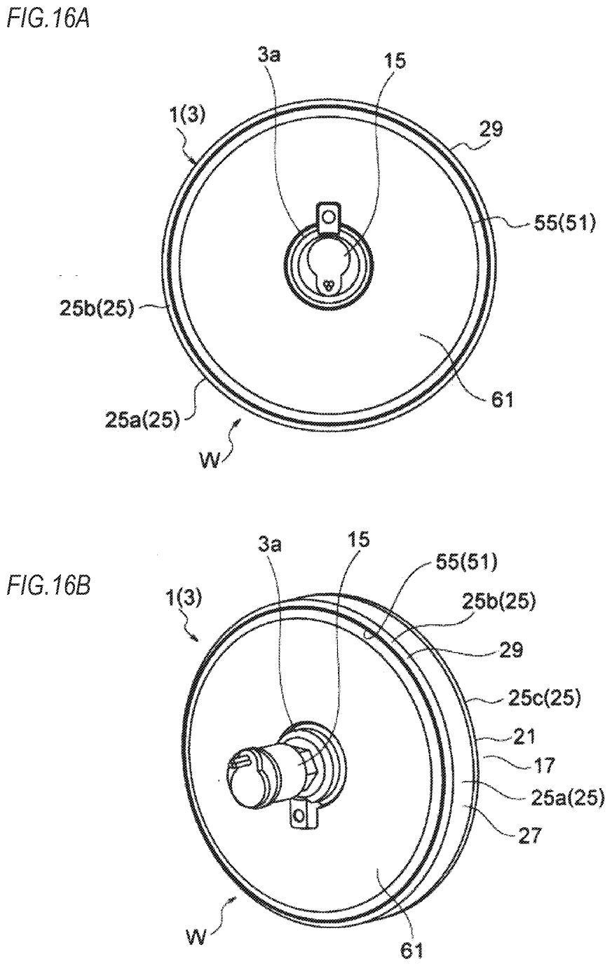

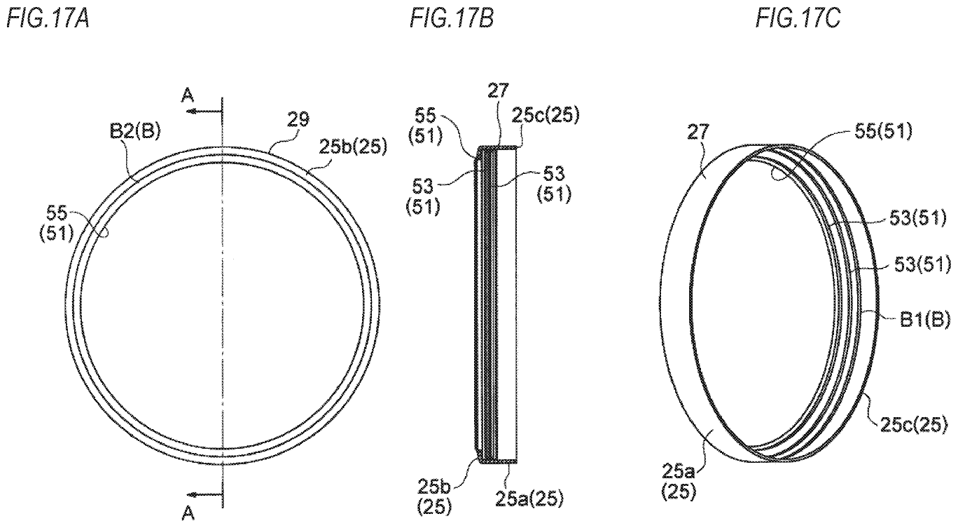

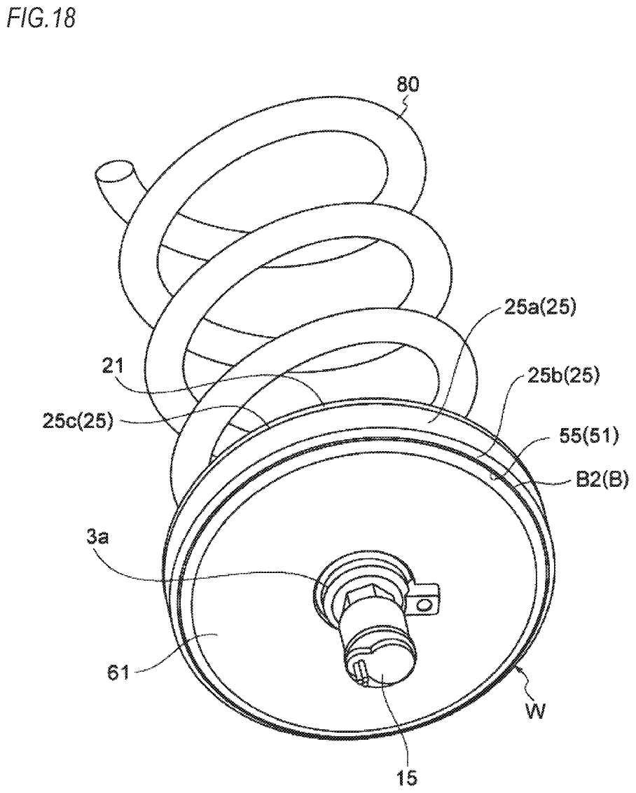

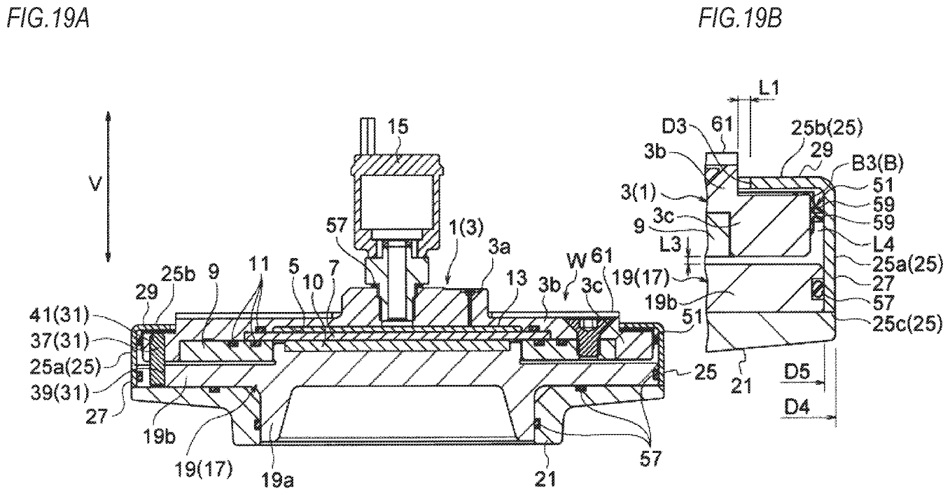

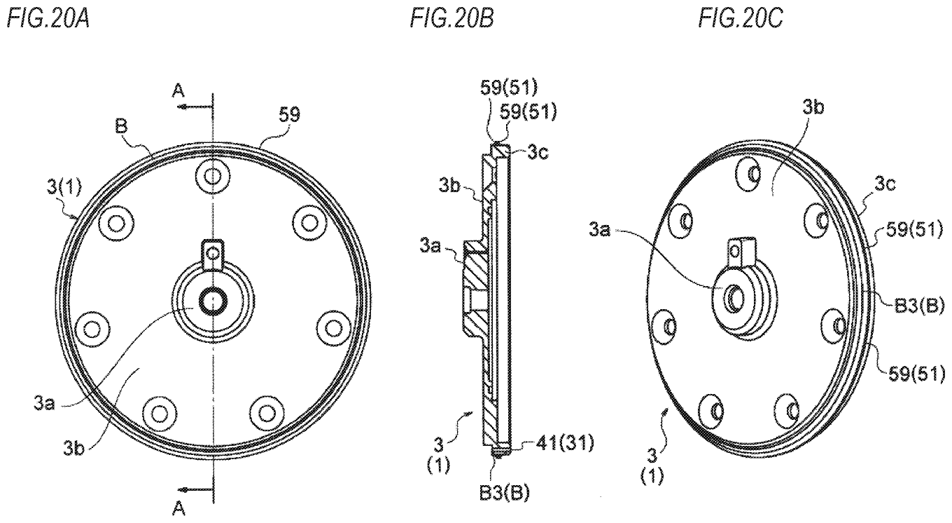

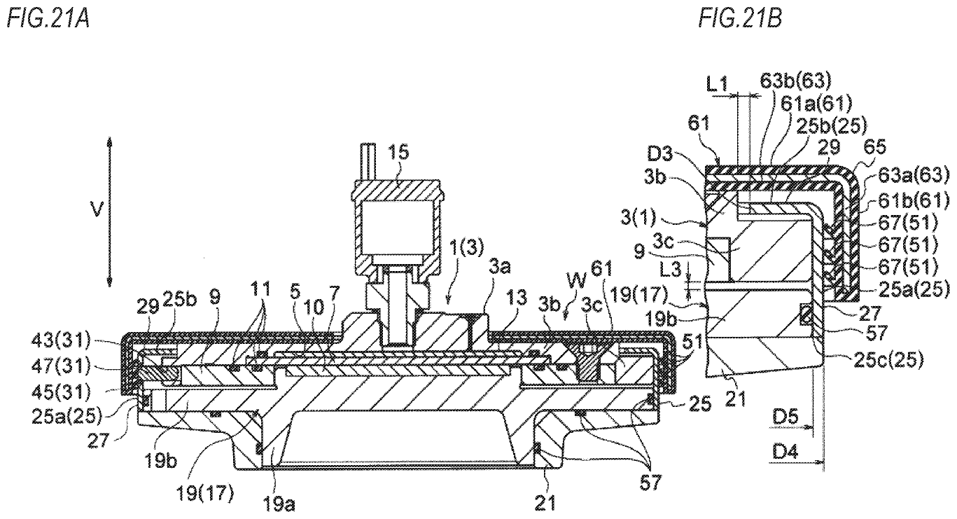

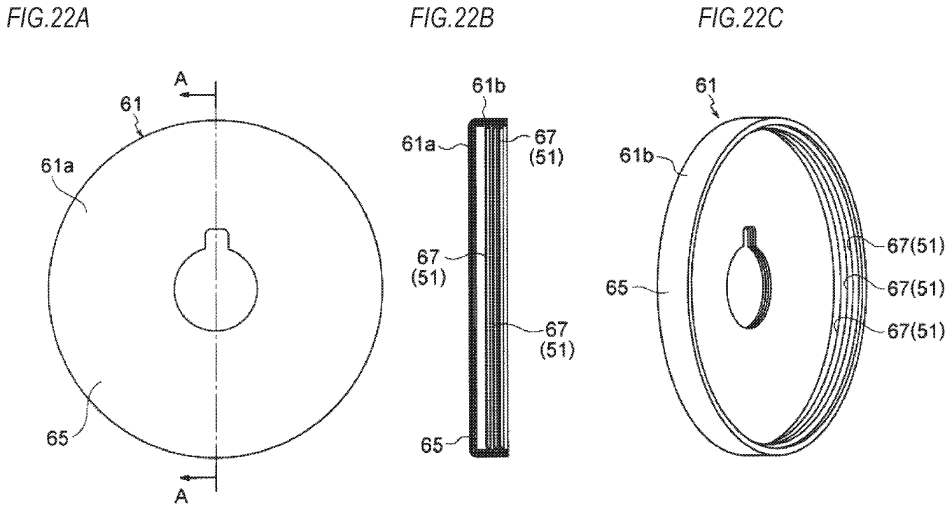

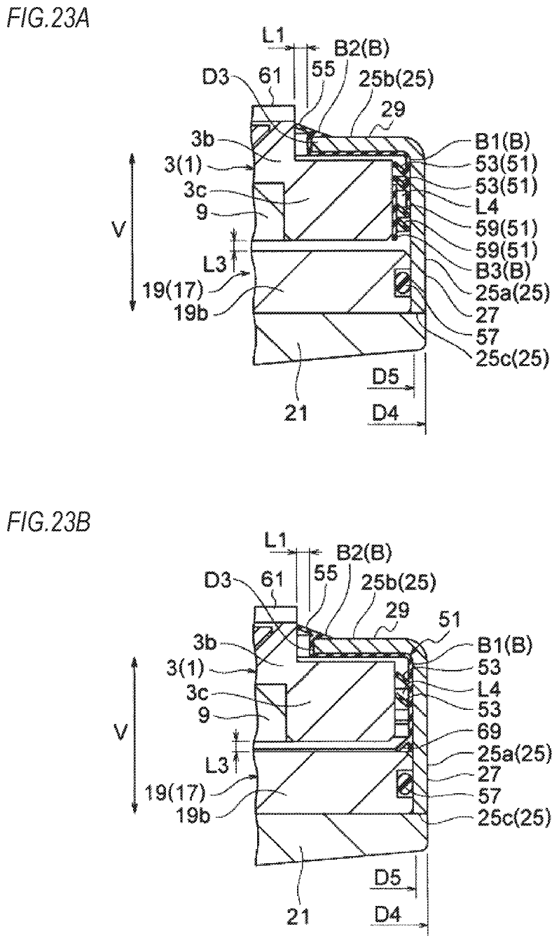

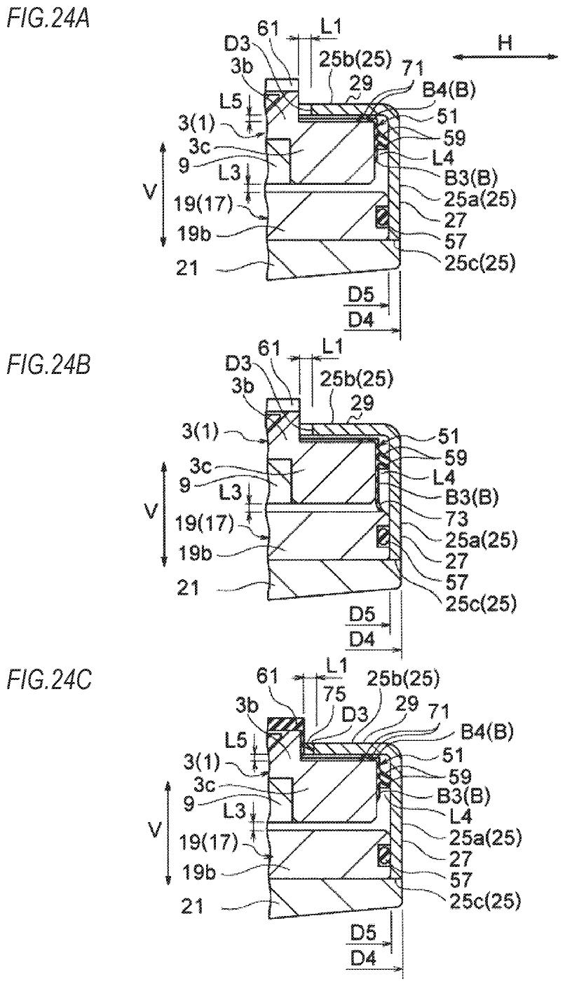

FIGS. 1 to 5 depict a first embodiment, FIGS. 6 to 9 depict a second embodiment, FIGS. 10 to 13 depict a third embodiment, FIGS. 15 to 18 depict a fourth embodiment, FIGS. 19 and 20 depict a fifth embodiment, FIGS. 21 and 22 depict a sixth embodiment, FIG. 23A depicts a seventh embodiment, FIG. 23B depicts an eighth embodiment, FIG. 24A depicts a ninth embodiment, FIG. 24B depicts a tenth embodiment, and FIG. 24C depicts an eleventh embodiment. In the meantime, the embodiments are just examples of the present invention, are not construed as being limited thereto, and can be design-changed within the scope of the present invention. According to the embodiments to be described later, it is possible to prevent introduction of foreign matters from a movement allowing gap of a moving body, which is inevitably formed between an attachment body and the moving body.

### First Embodiment

FIGS. 1 to 5 depict the first embodiment of the present invention. In the first embodiment, a vehicle weight measurement device W includes a moving body (piston part) 17 configured to move by resilient force of a spring (coil spring) 80, an attachment body (load detection part) 1 to be attached and fixed to an arm 90 of a suspension, a stopper ring 25 provided between the moving body (piston part) 17 and the attachment body (load detection part) 1 in an extending fashion, and a rotation prevention part 31 configured to prevent the moving body (piston part) 17 and the attachment body (load detection part) 1 from rotating relative to each other.

The attachment body 1 includes a bottom plate 3 having a lower surface to be in contact with the arm 90 of the suspension upon installation, a collar 9 provided on an upper surface of the bottom plate 3, a diaphragm 7 sandwiched and fixed by the bottom plate 3 and the collar 9, an oil chamber 13 formed between the bottom plate 3 and the diaphragm 7 and having a predetermined measurement fluid (operating oil) filled therein, and a pressure sensor 15 provided on the lower surface of the bottom plate 3 and capable of detecting a pressure change of the measurement fluid filled in the oil chamber 13.

In the first embodiment, the bottom plate 3 has a small-diameter cylindrical part 3a for coupling the pressure sensor 15, a circular disc-shaped first surface part 3b integrally formed continuously in a horizontal direction from an upper surface of the small-diameter cylindrical part 3a, and a circular ring-shaped second surface part 3c stepped from an upper surface of the first surface part 3b and integrally formed to have a diameter larger than the first surface part 3b. An outer periphery of the second surface part 3c is formed with a first notched groove 35. Also, the upper surface of the first surface part 3b is provided with a groove part 5 recessed in a direction of the lower surface thereof and having an opening region that is covered by the diaphragm 7 to thereby form the oil chamber 13.

Also, in the first embodiment, the collar 9 is formed to have a diameter larger than the opening region of the groove part 5, and is configured to sandwich, seal and fix a surface part close to an outer diameter of the diaphragm 7 between the collar and an outermore surface part than the opening region of the groove part 5. A reference sign 11 indicates a seal member (O-ring). Also, a reference sign 61 indicates a flat circular ring-shaped elastic plate (for example, rubber plate) made of a soft material and arranged on the first surface part 3b of the bottom plate 3.

The attachment body 1 of the first embodiment has a feature that the bottom plate 3 is provided with the first notched groove 35. Since the other shapes of the attachment body 1 may be the well-known shapes, an attachment body having other shape may also be adopted.

The moving body 17 includes a piston 19 in contact with the diaphragm 7 and capable of pressing the diaphragm 7 in a vertical direction (a direction shown with an arrow V in the drawings) and a spring seat 21 in contact with the piston 19, configured to receive one end (lower end) of a coil spring 80 of a suspension (not shown) and capable of pressing the piston 19 in the vertical direction V.

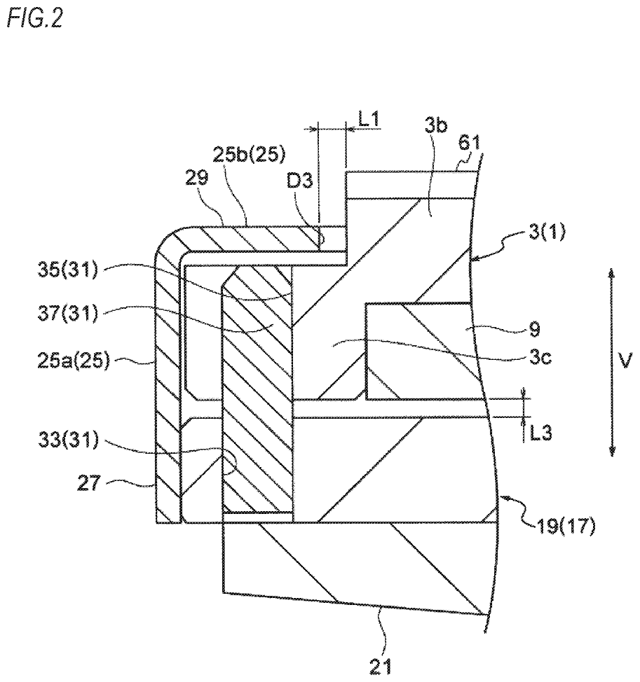

The piston 19 is arranged so that a movement allowing gap L3, in which the piston 19 can reciprocate in the vertical direction V, is to be formed between a lower surface surface facing the collar) of the piston 19 and an upper surface (a surface facing the piston) of the collar 9 (refer to FIG. 2).

In the first embodiment, the piston 19 has a flange part 19b integrally formed continuously in the horizontal direction from an outer periphery of a cylindrical part 19a, and a first fitting hole 33 formed closely to an outer diameter of the flange part 19b.

Also, a lower surface of the cylindrical part 19a is formed with a concave lower-side groove part 23 in which the pad 10 can be accommodated. The lower surface of the cylindrical part 19a is in contact with the diaphragm 7 via the pad 10 fitted and accommodated in the lower-side groove part 23. Also, in the first embodiment, the outer diameter of the flange part 19b of the piston 19 is slightly greater than an outer diameter of the second surface part 3c of the bottom plate 3.

The moving body 17 of the first embodiment has a feature that the piston 19 is provided with the first fitting hole 33. Since the others of the moving body 17 may be the well-known shapes, a moving body having other shape may also be adopted.

The stopper ring 25 is provided between the piston 19 and the bottom plate 3 in an extending fashion.

In the first embodiment, the stopper ring has a cylindrical part 25a formed to have a cylindrical shape and press-fitted and fixed to an outer periphery of the flange part 19b of the piston 19, and a circular ring part 25b provided continuously toward an axis center direction of the cylindrical part 25a from a lower surface of the cylindrical part 25a, having an inner diameter smaller than the outer diameter of the second surface part 3c of the bottom plate 3 and capable of being engaged to a lower surface (stepped part) of the second surface part 3c of the bottom plate 3.

Also, an upper surface of the cylindrical part 25a is opened. An inner diameter D3 of the circular ring part 25b is formed greater than an outer peripheral surface of the first surface part 3b of the bottom plate 3. A predetermined gap L1 is formed between the inner diameter D3 of the circular ring part 25b and the outer peripheral surface of the first surface part 3b of the bottom plate 3.

That is, a portion of the cylindrical part 25a fitted and fixed to the outer periphery of the flange part 19b of the piston 19 functions as a fixing part 27. The circular ring part 25b functions as a separation and detachment prevention part 29 configured to prevent the piston 19 from separating and detaching in a moving direction (which is the same as the vertical direction V).

The rotation prevention part 31 has such a configuration that a pin 37 is fitted from the piston 19 to the bottom plate 3, in the first embodiment.

The rotation prevention part 31 has the first fitting hole 33 formed in the flange part 19b of the piston 19, the first notched groove 35 formed in the second surface part 3c of the bottom plate 3, and the pint 37 capable of being fitted from the first fitting hole 33 to the first notched groove 35.

The first fitting hole 33 is formed to penetrate a part close to the outer periphery of the piston 19 from an upper surface to a lower surface in a cylindrical shape.

The first notched groove 35 is a long groove formed from an upper surface to a lower surface of the second surface part 3c of the bottom plate 3 and having a semicircular shape, as seen from above. The first notched groove 35 is coaxial with the first fitting hole

The pin 37 has a circular cylinder shape having a length protruding from the first fitting hole 33, and is fitted and fixed to the first fitting hole 33.

In the meantime, a configuration in which the pin 37 is formed to have a square tube shape, and the first fitting hole 33 and the first notched groove 35 are also formed to have a square tube shape is possible, which is within the scope of the present invention.

The rotation prevention part 31 configured by the combination of the first fitting hole 33, the first notched groove 35 and the pin 37 may be provided in plural.

According to the first embodiment, following operational effects are achieved.

The stopper ring 25 can be moved in a longitudinal direction (which is the same as the vertical direction V) of the suspension together with the piston 19 by the cylindrical part 25a (fixing part 27) press-fitted and fixed to the outer periphery of the piston 19 but prevents the piston 19 and the bottom plate 3 from separating and detaching by the circular ring part 25b (separation and detachment prevention part 29) capable of being engaged to the lower surface of the second surface part 3c of the bottom plate 3. Therefore, even before equipped to a vehicle, since it is possible to solve the concern that the bottom plate 3 (attachment body) and the piston 19 (moving body) are to be separated and detached by the simple and inexpensive configuration, it is also useful for transportation and the like to automobile assembly factories.

Also, since the pin 37 fitted and fixed to the first fitting hole 33 of the piston 19 is fitted to the first notched groove 35 of the bottom plate 3 to be fixed to the suspension, the rotation prevention part 31 of the first embodiment can prevent the bottom plate 3 (attachment body) and the piston 19 (moving body) from rotating relative to each other in the simple and inexpensive manner.

Therefore, in a state in which the vehicle is equipped with the weight measurement device W, there is no concern that the bottom plate 3 (attachment body) and the piston 19 (moving body) are to rotate relative to each other, and wears between the diaphragm 7 and the piston 19 are not caused.

Therefore, the first fitting hole 33 has only to be formed in the piston 19, so that it is possible to simplify the piston shape.

Meanwhile, in the first embodiment, the example in which the fixing part 27 of the stopper ring 25 is press-fitted and fixed to the flange part 19b of the piston 19 has been described. However, the stopper ring 25 may be fixed to the piston 19 in a swaging manner and can be design-changed within the scope of the present invention. Also, a material of the stopper ring 25 may be a cold-rolled steel plate. As the cold-rolled steel plate, SPCC, material, SPCD material, SPCE material and the like may be exemplified.

For example, as shown in FIG. 14, the load measurement device is provided in the vicinity of a wheel of an automobile. Therefore, when foreign matters such as muddy water are introduced into the load measurement device, strength reduction and function deficiency may be caused due to rust, corrosion and the like. In order to prevent the same, a surface of the cold-rolled steel plate of the stopper ring 25 is preferably formed of plating such as ho-dip galvanizing, electroplating, thin film organic composite plating or the like.

### Second Embodiment

FIGS. 6 to 9 relate to a second embodiment of the present invention, depicting another implementation example of the rotation prevention part 31 in the second embodiment. In the meantime, since the stopper ring 25 and the other configurations are the same as the first embodiment, the descriptions thereof are omitted.

The rotation prevention part 31 includes a second notched groove 39 provided in the piston 19, a second fitting hole 41 provided in the bottom plate 3 and the pin 37 fitted from the first notched groove 39 to the second fitting hole 41. That is, the second embodiment is different from the first embodiment, in that the second fitting hole 41 is formed instead of the first notched groove 35 of the bottom plate 3 described in the first embodiment and the second notched groove 39 is formed instead of the first fitting hole 33 of the piston 19.

The second notched groove 39 is a long groove formed from an upper surface to a lower surface closely to the outer diameter of the flange part 19b of the piston 19 and having a. semicircular shape, as seen from above. The second fitting hole 41 is formed to penetrate the second surface part 3c of the bottom plate 3 from the upper surface to the lower surface in a cylindrical shape.

The second notched groove 39 and the second fitting hole 41 are coaxially provided.

In the meantime, the configuration of the pin 37 is the same as the first embodiment.

The operational effects of the second embodiment are the same as the first embodiment and the descriptions thereof are thus omitted.

Also, the second notched groove 39 provided in the flange part 19b of the piston 19 may be replaced with a fitting hole similar to the second fitting hole 41 formed in the bottom plate 3, which is also within the scope of the present invention.

### Third Embodiment

FIGS. 10 to 13 relate to a third embodiment of the present invention, depicting another implementation example of the rotation prevention part 31 in the third embodiment. In the meantime, since the other configurations are the same as the first embodiment, the descriptions thereof are omitted.

The rotation prevention part 31 includes a third fitting hole 43 recessed in a cylindrical shape in the horizontal direction from the outer periphery of the bottom plate 3 toward the axis center direction, an insertion hole 45 provided in the cylindrical part 25a of the stopper ring 25, and a pin 47 fitted to the third fitting hole 43 and arranged in the insertion hole 45. That is, unlike the first embodiment or the second embodiment in which the bottom plate 3 and the piston 19 are coupled by the pin 37 and the bottom plate 3 and the piston 19 are thus prevented from rotating relative to each other, in the third embodiment, the bottom plate 3 and the stopper ring 2.5 are coupled by e pin 47 and the bottom plate 3 and the piston 19 are thus prevented from rotating relative to each other.

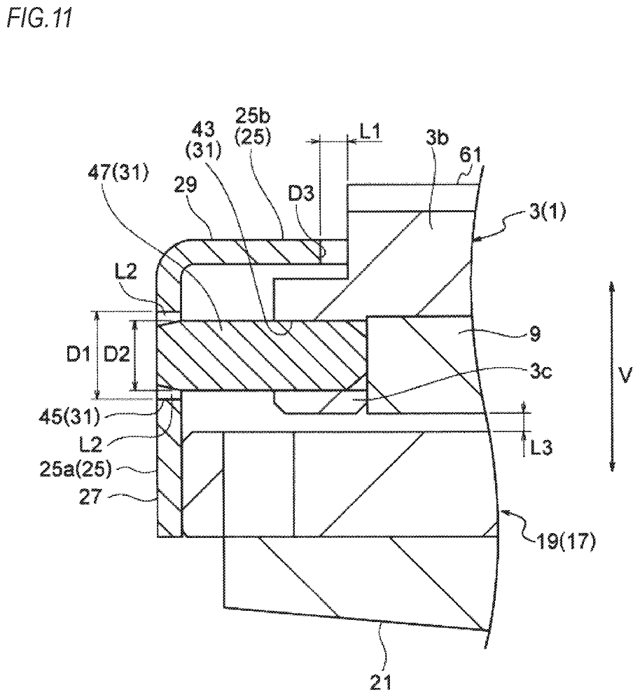

In FIG. 11, when a diameter of the insertion hole 45 is denoted as D1 and an outer diameter of the pin 47 is denoted as D2, D1 and D2 meet a relation of D1>D2.

That is, the stopper ring 25 should be configured to be movable in the vertical direction V together with the piston 19 to which the cylindrical part 25a (fixing part 27) is press-fitted and fixed. Therefore, the insertion hole 45 is formed to have a diameter greater than the pin 47, and a movement gap (movement space) L2 is formed around the pin 47.

The movement gap (movement space) L2 is set to be substantially the same as at least a distance in which the piston 19 (moving body 17) can move in the vertical direction V

In the meantime, the insertion hole 45 may be formed to have a diameter larger than the pin 47 in the vertical direction V and slightly larger than the pin 47 in a circumferential direction. That is, the insertion hole 45 may be formed as a hole that is long in the vertical direction V, inasmuch as it has a hole diameter within which the pin 47 can be inserted therein and can move in the vertical direction V.

According to the third embodiment, the rotation prevention part has such configuration that the pin 47 inserted in the insertion hole 45 formed in the cylindrical part 25a of the stopper ring 25 press-fitted and fixed to the outer periphery of the piston 19 is fitted and fixed to the third fitting hole 43 of the bottom plate 3. Therefore, the bottom plate 3 (attachment body) and the piston 19 (moving body) can be prevented from rotating relative to each other in the simple and inexpensive manner. Therefore, in the state in which the vehicle is equipped with the weight measurement device W, there is no concern that the bottom plate 3 (attachment body) and the piston 19 (moving body) are to rotate relative to each other, and wears between the bottom plate 3 (attachment body) and the piston 19 (moving body) are not caused.

The other operational effects are the same as the first embodiment and the descriptions thereof are thus omitted.

Subsequently, implementation examples in which a sealing mechanism 51 is provided are described as fourth to eleventh embodiments (refer to FIGS. 15 to 24). The sealing mechanism 51 is configured to prevent foreign matters from being introduced into a movement allowing gap L3 formed between the attachment body (collar 9) and the moving body (piston 19).

### Fourth Embodiment

FIGS. 15 to 18 depict a fourth embodiment. In the fourth embodiment, the stopper ring 25 is integrally provided with a sealing mechanism 51, in the weight measurement device W (refer to FIGS. 1 to 5) of the first embodiment.

Also, in the fourth embodiment, an outer diameter D4 of the spring seat 21 configuring the first embodiment is formed slightly greater than an outer diameter D5 of the flange part 19b of the piston 19.

In the fourth embodiment, only the sealing mechanism 51, which is a characteristic configuration, is described, and for the other configurations and operational effects, the descriptions of the first embodiment are cited.

The sealing mechanism 51 is a seal part formed integrally with the stopper ring 25 by nitrile rubber, for example. The sealing mechanism 51 has a base part B integrally fixed to cover a lower surface of the circular ring part 25b around the inner diameter D3 of the circular ring part 25b (separation and detachment prevention part 29) from an inner surface of the cylindrical part 25a of the stopper ring 25, first seal lips 53 and 53 provided in two lines in the vertical direction, having an annular shape and protruding in an inclined shape from a region B1 of the base part B fixed to the inner surface of the cylindrical part 25a, and a second seal lip 55 having an annular shape and protruding in an inclined shape from a region B2 of the base part B fixed to the lower surface of the circular ring part 25b.

The first seal lips 53 and 53 are in sliding contact (pressure contact) with an outer surface of the second surface part 3c of the bottom plate 3, thereby sealing a gap L4 between the inner surface of the cylindrical part 25a of the stopper ring 25 and the outer surface of the second surface part 3c of the bottom plate 3.

The second seal lip 55 is in sliding contact (pressure contact) with an outer surface of the first surface part 3b of the bottom plate 3, thereby sealing a gap LI between the inner diameter D3 of the circular ring part 25b of the stopper ring 25 and the outer surface of the first surface part 3b of the bottom plate 3.

In the fourth embodiment, the stopper ring 25 is incorporated, so that lip tips of the first seal lips 53 and 53 are pressure-contacted to the outer surface of the second surface part 3c of the bottom plate 3 and a lip tip of the second seal lip 55 is pressure-contacted to the outer surface of the first surface part 3b of the bottom plate 3.

For the sealing mechanism (seal part) 51, a material that is generally used as a seal material such as polyacryl rubber, silicon rubber, fluorine rubber and the like is arbitrarily selected.

In the meantime, an interval between the first seal lips 53 and 53 provided in two lines is arbitrary. The first seal lip 53 may be used in a single line or in three or more lines.

The second seal lip 55 may be used in two or more lines.

Also, the lip tip of the first seal lip 53 and the lip tip of the second seal lip 55 may be bifurcated.

According to the fourth embodiment, the second seal lip 55 is provided to seal the gap L1 between the inner diameter D3 of the circular ring part 25b of the stopper ring 25 and the outer surface of the first surface part 3b of the bottom plate 3, so that it is possible to prevent foreign matters from being introduced into the weight measurement device W from the gap L1.

Therefore, the introduction of foreign matters into the movement allowing gap L3 located on a more inner side than the gap L1 is prevented.

Also, even if the foreign matters pass through the gap L1, the introduction of the foreign matters into the movement allowing gap L3 is securely prevented by the first seal lips 53 and 53 provided in two lines (double manner) in the vertical direction and configured to seal the gap L4 between the inner surface of the cylindrical part 25a of the stopper ring 25 and the outer surface of the second surface part 3c of the bottom plate 3.

Therefore, it is possible to prevent problems that the movement of the moving body in the vertical direction V is obstructed due to the foreign matters and the weight cannot be thus accurately measured, and that the muddy water and the like are stagnant in the recess and rust, corrosion and the like are thus incurred to cause strength reduction, function deficiency and the like.

Furthermore, in the fourth embodiment, the outer diameter D4 of the spring seat 21 is formed slightly greater than the outer diameter D5 of the flange part 19b of the piston 19, and an upper end opening surface 25c of the stopper ring 25 is in close contact with the lower surface of the spring seat 21 (refer to FIG. 21). In this way, the upper end opening surface 25c of the stopper ring 25 is in close contact with the lower surface of the spring seat 21, so that the introduction of foreign matters is prevented.

Also, a contact region of the spring seat 21 and the piston 19 and a region in which the cylindrical part 25a of the stopper ring 25 functioning as the fixing part 27 and the outer periphery of the flange part 19b of the piston 19 are fitted and fixed are respectively provided with seal members (O-rings) 57 for improvement on scalability.

Therefore, an introduction route of the foreign matters from above the weight measurement device W is all sealed, so that the effect of preventing the introduction of foreign matters into the movement allowing gap L3 together with the sealing mechanism (seal part) 51 of the fourth embodiment is further improved.

Also, according to the fourth embodiment, the first seal lips 53 and 53 and the second seal lip 55 configuring the sealing mechanism 51 are formed integrally with the stopper ring 25. Therefore, when the cylindrical part 25a of the stopper ring 25 functioning as the fixing part 27 is press-fitted and fixed to the outer surface of the flange part 19b of the piston 19, the separation and detachment of the piston 19 and the bottom plate 3 is prevented and the required gap is sealed to prevent the introduction of foreign matters into the movement allowing gap L3. Therefore, it is not necessary to separately perform processing for preventing the introduction of foreign matters into the movement allowing gap L3, so that the procedure is simplified.

In the meantime, the sealing mechanism 51 of the fourth embodiment can be applied to the weight measurement device W of the second embodiment and the third embodiment, too.

### Fifth Embodiment

FIGS. 19 and 20 depict a fifth embodiment. In the fifth embodiment, the bottom plate 3 is integrally provided with the sealing mechanism (seat part) 51, in the weight measurement device W (refer to FIGS. 6 to 9) described in the second embodiment.

Also, in the fifth embodiment, the outer diameter D4 of the spring seat 21 configuring the second embodiment is formed slightly greater than the outer diameter D5 of the flange part 19b of the piston 19.

In the fifth embodiment, only the sealing mechanism 51, which is a characteristic configuration, is described, and for the other configurations and operational effects, the descriptions of the first embodiment, the second embodiment and the fourth embodiment are cited.

The sealing mechanism (seal part) 51 has a base part B integrally fixed to cover an outer surface and a lower end surface of the second surface part 3c of the bottom plate 3, and third seal lips 59 and 59 provided in two lines in the vertical direction, having an annular shape and protruding in an inclined shape from a base part region B3 fixed to the outer surface.

The third seal lips 59 and 59 are in sliding contact (pressure contact) with the inner surface of the cylindrical part 25a of the stopper ring 25, thereby sealing the gap L4 between the inner surface of the cylindrical part 25a of the stopper ring 25 and the outer surface of the second surface part 3c of the bottom plate 3.

In the fifth embodiment, the stopper ring 25 is incorporated, so that lip tips of the third seal lips 59 and 59 are pressure-contacted to the inner surface of the cylindrical part 25a of the stopper ring 25.

In the meantime, an interval between the third seal lips 59 and 59 provided in two lines is arbitrary. The third seal lip 59 may be used in a single line or in three or more lines.

Also, the lip tip of the third seal lip 59 may be bifurcated.

According to the fifth embodiment, the introduction of the foreign matters into the movement allowing gap L3 is securely prevented by the third seal lips 59 and 59 provided in two lines (double manner) in the vertical direction V and configured to seal the gap L4 between the inner surface of the cylindrical part 25a of the stopper ring 25 and the outer surface of the second surface part 3c of the bottom plate 3.

Therefore, it is possible to prevent problems that the movement of the moving body in the vertical direction V is obstructed due to the foreign matters and the weight cannot be thus accurately measured, and that the muddy water and the like are stagnant in the recess and rust, corrosion and the like are thus incurred to cause strength reduction, function deficiency and the like.

Also, according to the fifth embodiment, the third seal lips 59, 59 and 59 configuring the sealing mechanism 51 are formed integrally with the bottom plate 3. Therefore, when the cylindrical part 25a of the stopper ring 25 is press-fitted and fixed to the outer surface of the flange part 19b of the piston 19, the separation and detachment of the piston 19 and the bottom plate 3 is prevented and the gap L4 is sealed to prevent the introduction of foreign matters into the movement allowing gap L3. Therefore, it is not necessary to separately perform processing for preventing the introduction of foreign matters into the movement allowing gap L3, so that the procedure is simplified.

In the meantime, the sealing mechanism 51 of the fifth embodiment can be applied to the weight measurement device W of the first embodiment, too.

### Sixth Embodiment

FIGS. 21 and 22 depict a sixth embodiment. In the sixth embodiment, the elastic plate 61 is integrally provided with the sealing mechanism (seat part) 51, in the weight measurement device W (refer to FIGS. 10 to 13) described in the third embodiment.

Also, in the sixth embodiment, the outer diameter D4 of the spring seat 21 configuring the third embodiment is formed slightly greater than the outer diameter D5 of the flange part 19b of the piston 19, and the elastic plate 61 is formed to have a tube shape.

In the sixth embodiment, only the sealing mechanism 51, which is a characteristic configuration, is described, and for the other configurations and operational effects, the descriptions of the first embodiment, the third embodiment and the fourth embodiment are cited.

In the sixth embodiment, the elastic plate 61 has a metal insert 63, a soft cover insert 65, and a fourth seal lip 67. The metal insert 63 has a circular ring part 63a, and a cylindrical part 63b integrally formed upward from an outer diameter of the circular ring part 63a. The soft cover insert 65 is formed to cover an entire area of the metal insert 63. The elastic plate 61 is formed into a bottomed cylindrical shape having a lower surface 61a and a tube-shaped side surface 61b by the metal insert 63 and the cover insert 65. Also, the elastic plate 61 has the fourth seal lip 67 integrally protruding from an inner surface of the tube-shaped side surface 61b of the soft cover insert 65.

In the meantime, the metal insert 63 is formed by performing punching and plastic processing such as press working on a metal material usually used as a seal metal insert, such as cold-rolled steel plate of SPCC, SPCD or the like.

The lower surface 61a is formed to have a diameter greater than the first surface part 3b of the bottom plate 3 and the stopper ring 25. The lower surface 61a is arranged in contact (close contact) with the first surface part 3b of the bottom plate 3 (refer to FIG. 21).

The tube-shaped side surface 61b is arranged to surround an outer surface of the cylindrical part 25a of the stopper ring 25 (refer to FIG. 21).

The sealing mechanism (seal part) 51 is configured by fourth seal lips 67, 67 and 67 provided in three lines in the vertical direction V, having an annular shape and protruding in an inclined shape from a cover part region covering an inner peripheral surface of the cylindrical part 63b.

The fourth seal lip 67 is in sliding contact (pressure contact) with the outer surface of the cylindrical part 25a of the stopper ring 25, thereby sealing space between the fourth seal lip and the outer surface of the cylindrical part 25a of the stopper ring 25.

In the meantime, intervals between the fourth seal lips 67, 67 and 67 provided in three lines are arbitrary. The fourth seal lip 67 may be used in a single line or in four or more lines.

Also, the lip tip of the fourth seal lip 67 may be bifurcated.

According to the sixth the embodiment, the fourth seal lips 67, 67 and 67 provided in three lines (triple manner) in the vertical direction V and configured to seal the outer surface of the cylindrical part 25a of the stopper ring 25, so that the introduction of foreign matters into the movement allowing gap L3 is securely prevented.

Therefore, it is possible to prevent problems that the movement of the moving body in the vertical direction V is obstructed due to the foreign matters and the weight cannot be thus accurately measured, and that the muddy water and the like are stagnant in the recess and rust, corrosion and the like are thus incurred to cause strength reduction, function deficiency and the like.

In the meantime, the sealing mechanism (seal part) 51 of the first embodiment or the sealing mechanism (seal part 51) of the second embodiment can be used together with the sealing mechanism (seal part) 51 of the sixth embodiment, which is within the scope of the present invention.

Also, according to the sixth embodiment, the fourth seal lips 67, 67 and 67 configuring the sealing mechanism 51 are formed integrally with the elastic plate 61. Therefore, when the elastic plate 61 is arranged to cover the outer surface of the cylindrical part 25a of the stopper ring 25, the required gap between the elastic plate and the outer surface of the cylindrical part 25a of the stopper ring 25 is sealed to prevent the introduction of foreign matters into the movement allowing gap L3, at the same time of the arrangement of the elastic plate 61. Therefore, it is not necessary to separately perform processing for preventing the introduction of foreign matters into the movement allowing gap L3, so that the procedure is simplified.

In the meantime, the sealing mechanism 51 of the sixth embodiment can be applied to the weight measurement device W of the first embodiment or the second embodiment, too.

### Seventh Embodiment

FIG. 23A depicts a seventh embodiment. In the seventh embodiment, both the stopper ring 25 and the bottom plate 3 are integrally provided with the sealing mechanism (seat part) 51, in the weight measurement device W (refer to FIGS. 1 to 13) described in the first embodiment to the third embodiment.

Also, in the seventh embodiment, the outer diameter D4 of the spring seat 21 configuring the first embodiment to the third embodiment is formed slightly greater than the outer diameter D5 of the flange part 19b of the piston 19.

In the seventh embodiment, only the sealing mechanism 51, which is a characteristic configuration, is described, and for the other configurations and operational effects, the descriptions of the first embodiment to the fourth embodiment are cited.

In the seventh embodiment, the sealing mechanism (seal part) 51 is configured by a combination of the sealing mechanism 51 (first seal lip 53 and second seal lip 55) described in the fourth embodiment and the sealing mechanism 51 (third seal lip 59) described in the fifth embodiment.

The second seal lip 55 is in sliding contact (pressure contact) with the outer surface of the first surface part 3b of the bottom plate 3. The first seal lips 53 and 53 are formed in two lines in the vertical direction V, and are in sliding contact (pressure contact) with the outer surface of the second surface part 3c of the bottom plate 3. The third seal lips 59 and 59 are formed in two lines in the vertical direction V, and are in sliding contact (pressure contact) with the inner surface of the cylindrical part 25a of the stopper ring 25.

Also, the first seal lip 53 seals in the vicinity of the gap The third seal lip 59 seals in the vicinity of the movement allowing gap L3. Therefore, the gap L4 between the inner surface of the cylindrical part 25a of the stopper ring 25 and the outer surface of the second surface part 3c of the bottom plate 3 is quadruply sealed.

In the seventh embodiment, the stopper ring 25 is incorporated, so that the lip tips of the first seal lips 53 and 53 are pressure-contacted to the outer surface of the second surface part 3c of the bottom plate 3, the lip tip of the second seal lip 55 is pressure-contacted to the outer surface of the first surface part 3b of the bottom plate 3 and the lip tips of the third seal lips 59 and 59 are pressure-contacted to the inner surface of the cylindrical part 25a of the stopper ring 25.

In the meantime, an interval between the first seal lips 53 and 53 provided in two lines and an interval between the third seal lips 59 and 59 provided in two lines are arbitrary, respectively. Also, the first seal lip 53 and the third seal lip 59 may be used in a single line or in three or more lines, respectively. Also, an interval between the first seal lip 53 and the third seal lip 59 is arbitrary.

Also, the lip tips of the first seal lip 53, the second seal lip 55 and the third seal lip 59 may be bifurcated, respectively.

According to the seventh embodiment, the second seal lip 55 seals the gap L1 between the inner diameter D3 of the circular ring part 25b of the stopper ring 25 and the outer surface of the first surface part 3b of the bottom plate 3. Also, the gap L4 between the inner surface of the cylindrical part 25a of the stopper ring 25 and the outer surface of the second surface part 3c of the bottom plate 3 is sealed quadruply by the first seal lips 53 and 53 and the third seal lips 59 and 59. Therefore, the introduction of foreign matters into the movement allowing gap L3 is securely prevented.

Therefore, it is possible to prevent problems that the movement of the moving body in the vertical direction is obstructed due to the foreign matters and the weight cannot be thus accurately measured, and that the muddy water and the like are stagnant in the recess and rust, corrosion and the like are thus incurred to cause strength reduction, function deficiency and the like.

In the meantime, the sealing mechanism (seal part) 51 of the sixth embodiment having the fourth seal lips 67, 67 and 67 can be used together with the sealing mechanism (seal part) 51 of the seventh embodiment, which is within the scope of the present invention.

### Eighth Embodiment

FIG. 23B depicts an eighth embodiment. In the eighth embodiment, the stopper ring 25 is integrally provided with the sealing mechanism (seat part) 51, in the weight measurement device W (refer to FIGS. 1 to 13) described in the first embodiment to the third embodiment.

Meanwhile, in the eighth embodiment, the outer diameter D4 of the spring seat 21 configuring the first embodiment to the third embodiment is formed slightly greater than the outer diameter D5 of the flange part 19b of the piston 19.

In the eighth embodiment, only the sealing mechanism 51, which is a characteristic configuration, is described, and for the other configurations, the descriptions of the first embodiment to the fourth embodiment are cited.

The sealing mechanism (seal part) 51 has the second seal lips 55 and 55 described in the first embodiment, and a fifth seal lip 69 having an annular shape, protruding in an inclined shape from an upper end region of the region B1 of the base part B, which is fixed to the inner surface of the cylindrical part 25a, toward the lower surface (a surface facing the collar) of the piston 19, and being in sliding contact (pressure contact) with the lower surface (a surface facing the collar) of the piston 19.

The second seal lip 55 is in sliding contact (pressure contact) with the outer surface of the first surface part 3b of the bottom plate 3 The first seal lips 53 and 53 are formed in two lines in the vertical direction V, and are in sliding contact (pressure contact) with the outer surface of the second surface part 3c of the bottom plate 3. The fifth seal lip 69 is in sliding contact (pressure contact) with the lower surface (a surface facing the collar) of the piston 19.

Therefore, the gap L1 between the inner diameter D3 of the circular ring part 25b of the stopper ring and the outer surface of the first surface part 3b of the bottom plate 3, the gap L4 between the inner surface of the cylindrical part 25a of the stopper ring 25 and the outer surface of the second surface part 3c of the bottom plate 3, and the movement allowing gap L3 are sealed quadruply.

In the eighth embodiment, the stopper ring 25 is incorporated, so that the lip tips of the first seal lips 53 and 53 are pressure-contacted to the outer surface of the second surface part 3c of the bottom plate 3, the lip tip of the second seal lip 55 is pressure-contacted to the outer surface of the first surface part 3b of the bottom plate 3, and a lip tip of the fifth seal lip 69 is pressure-contacted to the lower surface (a surface facing the collar) of the piston 19 when the upper end opening surface 25c of the cylindrical part 25a of the stopper ring 25 is closely contacted to the lower surface of the spring seat 21.

In the meantime, the fifth seal lip 69 may be used in plurality of (two or more) lines. Also, the lip tip of the fifth seal lip 69 may be bifurcated.

According to the eighth embodiment, the second seal lip 55 seals the gap L1 between the inner diameter D3 of the circular ring part 25b of the stopper ring 25 and the outer surface of the first surface part 3b of the bottom plate 3 and the first seal lips 53 and 53 seal the gap L4 between the inner surface of the cylindrical part 25a of the stopper ring 25 and the outer surface of the second surface part 3c of the bottom plate 3. Therefore, it is possible to prevent the foreign matters from being introduced from below the weight measurement device W (from the gap L1 direction). Also, since the fifth seal lip 69 seals the lower surface (a surface facing the collar) of the piston 19, it is possible to prevent the foreign matters from being introduced from above the weight measurement device W (from between the upper end opening surface 25c of the stopper ring 25 and the spring seat 21).

Therefore, since it is possible to effectively prevent the introduction of foreign matters into the movement allowing gap L3, it is possible to prevent problems that the movement of the moving body in the vertical direction is obstructed due to the foreign matters and the weight cannot be thus accurately measured, and that the muddy water and the like are stagnant in the recess and rust, corrosion and the like are thus incurred to cause strength reduction, function deficiency and the like.

In the meantime, the sealing mechanism (seal part) 51 of the sixth embodiment having the fourth seal lips 67, 67 and 67 can be used together with the sealing mechanism (seal part) 51 of the eighth embodiment, which is within the scope of the present invention.

### Ninth Embodiment

FIG. 24A depicts a ninth embodiment. In the ninth embodiment, the bottom plate 3 is integrally provided with the sealing mechanism (seat part) 51, in the weight measurement device W (refer to FIGS. 1 to 13) described in the first embodiment to the third embodiment.

Meanwhile, in the ninth embodiment, the outer diameter D4 of the spring seat 21 configuring the first embodiment to the third embodiment is formed slightly greater than the outer diameter D5 of the flange part 19b of the piston 19.

In the ninth embodiment, only the sealing mechanism 51, which is a characteristic configuration, is described, and for the other configurations, the descriptions of the first embodiment to the fourth embodiment are cited.

The sealing mechanism (seal part) 51 of the ninth embodiment has a seal lip further added to the sealing mechanism 51 described in the second embodiment. That is, the sealing mechanism (seal part) 51 has the third seal lips 59 and 59, and sixth seal lips 71 and 71 having an annular shape, protruding in an inclined shape from a region B4 of the base part B, which is fixed to the lower surface of the second surface part 3c, toward the inner surface of the circular ring part 25b of the stopper ring 25, and being in sliding contact (pressure contact) with the inner surface of the circular ring part 25b.

According to the ninth embodiment, the third seal lips 59 and 59 are formed in two lines in the vertical direction V, and are in sliding contact (pressure contact) with the inner surface of the cylindrical part 25a of the stopper ring 25. The sixth seal lips 71 and 71 are formed in two lines in the horizontal direction H, and are in sliding contact (pressure contact) with the inner surface of the circular ring part 25b of the stopper ring 25.

Therefore, the gap L4 between the inner surface of the cylindrical part 25a of the stopper ring 25 and the outer surface of the second surface part 3c of the bottom plate 3 and the gap L5 between the lower surface of the second surface part 3c and the inner surface of the circular ring part 25b of the stopper ring 25 are sealed quadruply.

In the ninth embodiment, the stopper ring 25 is incorporated, so that the lip tips of the third seal lips 59 and 59 are pressure-contacted to the inner surface of the cylindrical part 25a of the stopper ring 25 and lip tips of the sixth seal lips 71 and 71 are pressure-contacted to the inner surface of the circular ring part 25b of the stopper ring 25 when the upper end opening surface 25c of the cylindrical part 25a of the stopper ring 25 is closely contacted to the lower surface of the spring seat 21.

In the meantime, the sixth seal lip 71 may be used in a single line. Also, the lip tip of the sixth seal lip 71 may be bifurcated.

According to the ninth embodiment, the third seal lips 59 and 59 seal the gap L4 between the inner surface of the cylindrical part 25a of the stopper ring 25 and the outer surface of the second surface part 3c of the bottom plate 3, and the sixth seal lips 71 and 71 seal the gap L5 between the inner surface of the circular ring part 25b of the stopper ring 25 and the lower surface of the second surface part 3c of the bottom plate 3. Therefore, it is possible to prevent the introduction of foreign matters from below of the weight measurement device W (from the gap L1 direction).

Therefore, since it is possible to effectively prevent the introduction of foreign matters into the movement allowing gap L3, it is possible to prevent problems that the movement of the moving body in the vertical direction is obstructed due to the foreign matters and the weight cannot be thus accurately measured, and that the muddy water and the like are stagnant in the recess and rust, corrosion and the like are thus incurred to cause strength reduction, function deficiency and the like.

In the meantime, the sealing mechanism (seal part) 51 of the sixth embodiment having the fourth seal lips 67, 67 and 67 can be used together with the sealing mechanism (seal part) 51 of the ninth embodiment, which is within the scope of the present invention.

### Tenth Embodiment

FIG. 24B depicts a tenth embodiment. In the tenth embodiment, the bottom plate 3 is integrally provided with the sealing mechanism (seat part) 51, in the weight measurement device W (refer to FIGS. 1 to 13) described in the first embodiment to the third embodiment.

Meanwhile, in the tenth embodiment, the outer diameter D4 of the spring seat 21 configuring the first embodiment to the third embodiment is formed slightly greater than the outer diameter D5 of the flange part 19b of the piston 19.

In the tenth embodiment, only the sealing mechanism 51, which is a characteristic configuration, is described, and for the other configurations, the descriptions of the first embodiment to the fourth embodiment are cited.

The sealing mechanism (seal part) 51 of the tenth embodiment has a seal lip further added to the sealing mechanism 51 described in the second embodiment. That is, the sealing mechanism (seal part) 51 has the third seal lips 59 and 59, and a seventh seal lip 73 having an annular shape, protruding in an inclined shape from an upper end region of the region B3 of the base part B, which is fixed to the outer surface of the second surface part 3c, toward the lower surface (a surface facing the collar) of the piston 19, and being in sliding contact (pressure contact) with the lower surface (a surface facing the collar) of the piston 19.

According to the tenth embodiment, the third seal lips 59 and 59 are formed in two lines in the vertical direction V, and are in sliding contact (pressure contact) with the inner surface of the cylindrical part 25a of the stopper ring 25. The seventh seal lip 73 is formed in a single line, and is in sliding contact (pressure contact) with the lower surface (a surface facing the collar) of the piston 19.

Therefore, the gap L4 between the inner surface of the cylindrical part 25a of the stopper ring 25 and the outer surface of the second surface part 3c of the bottom plate 3 and the movement allowing gap L3 are sealed triply.

In the tenth embodiment, the stopper ring 25 is incorporated, so that the lip tips of the third seal lips 59 and 59 are pressure-contacted to the inner surface of the cylindrical part 25a of the stopper ring 25 and a lip tip of the seventh seal lip 73 is pressure-contacted to the lower surface (a surface facing the collar) of the piston 19 when the upper end opening surface 25c of the cylindrical part 25a of the stopper ring 25 is closely contacted to the lower surface of the spring seat 21.

In the meantime, the seventh seal lip 73 may be used in two lines. Also, the lip tip of the seventh seal lip 73 may be bifurcated.

According to the tenth embodiment, since the third seal lips 59 and 59 seal the gap L4 between the inner surface of the cylindrical part 25a of the stopper ring 25 and the outer surface of the second surface part 3c of the bottom plate 3, it is possible to prevent the introduction of foreign matters from below of the weight measurement device W (from the gap L1 direction).

Also, since the seventh seal lip 73 seals the movement allowing gap L3, it is possible to prevent the introduction of foreign matters into the movement allowing gap L3 from above the weight measurement device W (from between the upper end opening surface 25c of the stopper ring 25 and the spring seat 21).

Therefore, since it is possible to effectively prevent the introduction of foreign matters into the movement allowing gap L3, it is possible to prevent problems that the movement of the moving body in the vertical direction is obstructed due to the foreign matters and the weight cannot be thus accurately measured, and that the muddy water and the like are stagnant in the recess and rust, corrosion and the like are thus incurred to cause strength reduction, function deficiency and the like.

In the meantime, the sealing mechanism (seal part) 51 of the sixth embodiment having the fourth seal lips 67, 67 and 67 can be used together with the sealing mechanism (seal part) 51 of the tenth embodiment, which is within the scope of the present invention.

### Eleventh Embodiment

FIG. 24C depicts an eleventh embodiment. In the eleventh embodiment, both the bottom plate 3 and the elastic plate 61 are integrally provided with the sealing mechanisms (seat parts) 51 and 51, in the weight measurement device W (refer to FIGS. 1 to 13) described in the first embodiment to the third embodiment.

Meanwhile, in the eleventh embodiment, the outer diameter D4 of the spring seat 21 configuring the first embodiment to the third embodiment is formed slightly greater than the outer diameter D5 of the flange part 19b of the piston 19.

In the eleventh embodiment, only the sealing mechanism 51, which is a characteristic configuration, is described, and for the other configurations, the descriptions of the first embodiment to the fourth embodiment are cited.

The sealing mechanism (seal part) 1 of the eleventh embodiment has a seal lip further added to the sealing mechanism 51 described in the second embodiment. That is, the sealing mechanism (seal part) 51 has the third seal lips 59 and 59, and an eighth seal lip 75 having an annular shape, protruding in an inclined shape from an outer surface of an elastic region B5, which extends integrally upward in the vertical direction from the outer diameter of the elastic plate 61 along the outer surface of the first surface part 3b of the bottom plate 3, toward the inner diameter D3 of the circular ring part 25b of the stopper ring 25, and being in sliding contact (pressure contact) with the inner diameter D3 of the circular ring part 25b.

Also, the reference sign 71 is the same as the sixth seal lips 71 and 71 of the ninth embodiment in sliding contact (pressure contact) with the inner surface of the circular ring part 25b.

In the meantime, the elastic plate 61 of the eleventh embodiment may be an elastic plate having a metal insert incorporated therein, like the elastic plate 61 described in the sixth embodiment.

According to the eleventh embodiment, the third seal lips 59 and 59 are formed in two lines in the vertical direction V and are in sliding contact (pressure contact) with the inner surface of the cylindrical part 25a of the stopper ring 25, and the eighth seal lip 75 is formed in a single line and is in sliding contact (pressure contact) with the inner diameter D3 of the circular ring part 25b of the stopper ring 25.

Therefore, the gap L4 between the inner surface of the cylindrical part 25a of the stopper ring 25 and the outer surface of the second surface part 3c of the bottom plate 3 and the gap between the inner diameter D3 of the circular ring part 25b of the stopper ring 25 and the outer surface of the first surface part 3b of the bottom plate 3 are sealed triply.

In the eleventh embodiment, the stopper ring 25 is incorporated, so that the lip tips of the third seal lips 59 and 59 are pressure-contacted to the inner surface of the cylindrical part 25a of the stopper ring 25, and when the upper end opening surface 25c of the cylindrical part 25a of the stopper ring 25 is closely contacted to the lower surface of the spring seat 21, the lip tips of the sixth seal lips 71 and 71 are pressure-contacted to the inner surface of the circular ring part 25b of the stopper ring 25 and the lip tip of the eighth seal lip 75 is pressure-contacted to the inner diameter D3 of the circular ring part 25b.

In the meantime, the eighth seal lip 75 may be used in two lines. Also, the lip tip of the eighth seal lip 75 may be bifurcated.

According to the eleventh embodiment, since the third seal lips 59 and 59 seal the gap L4 between the inner surface of the cylindrical part 25a of the stopper ring 25 and the outer surface of the second surface part 3c of the bottom plate 3 and the eighth seal lip 75 seals the gap L1, it is possible to prevent the introduction of foreign matters from below the weight measurement device W (from the gap L1 direction).

Therefore, since it is possible to effectively prevent the introduction of foreign matters into the movement allowing gap L3, it is possible to prevent problems that the movement of the moving body in the vertical direction is obstructed due to the foreign matters and the weight cannot be thus accurately measured, and that the muddy water and the like are stagnant in the recess and rust, corrosion and the like are thus incurred to cause strength reduction, function deficiency and the like.

In the meantime, the sealing mechanism (seal part) 51 of the sixth embodiment having the fourth seal lips 67, 67 and 67 can be used together with the sealing mechanism (seal part) 51 of the eleventh embodiment, which is within the scope of the present invention.

### Other Embodiments

Although not shown, the seal part may be provided in the movement allowing gap formed between the attachment body and the moving body, inasmuch as it does not obstruct the movement of the moving body in the vertical direction V That is, for example, the surface of the attachment body (collar) facing the piston may be integrally formed with the seal part, and the seal lip thereof may be in sliding contact with the facing surface (lower surface) of the moving body (piston). Also, the surface of the moving body (piston) facing the collar may be integrally formed with the seal part, and the seal lip thereof may be in sliding contact with the surface of the attachment body (collar) facing the piston.

Also, the design may be changed within the scope of the present invention, inasmuch as the seal part (sealing mechanism) configuration capable of preventing the instruction of foreign matters such as water and dust into the movement allowing gap L3 is adopted.

In the meantime, the respective embodiments can be applied to a suspension for front wheels, too. Although not shown, for example, a vehicle weight measurement device for front wheels including an attachment body (load detection part) having a top plate, which is to be attached and fixed to a frame (cross member) of a vehicle main body of a vehicle, and a moving body (piston part) fixed to an axle via a lower arm, and configured to receive an upper end of a coil spring and to move by resilient force of the coil spring is also possible. That is, an optimal embodiment can be applied depending on specifications.

An embodiment to be described below relates to an implementation example in which the vehicle weight measurement device of the present invention is used for a suspension of an automobile.

Also, in the embodiment below, an implantation example in which the present invention is applied to a suspension for front wheels.

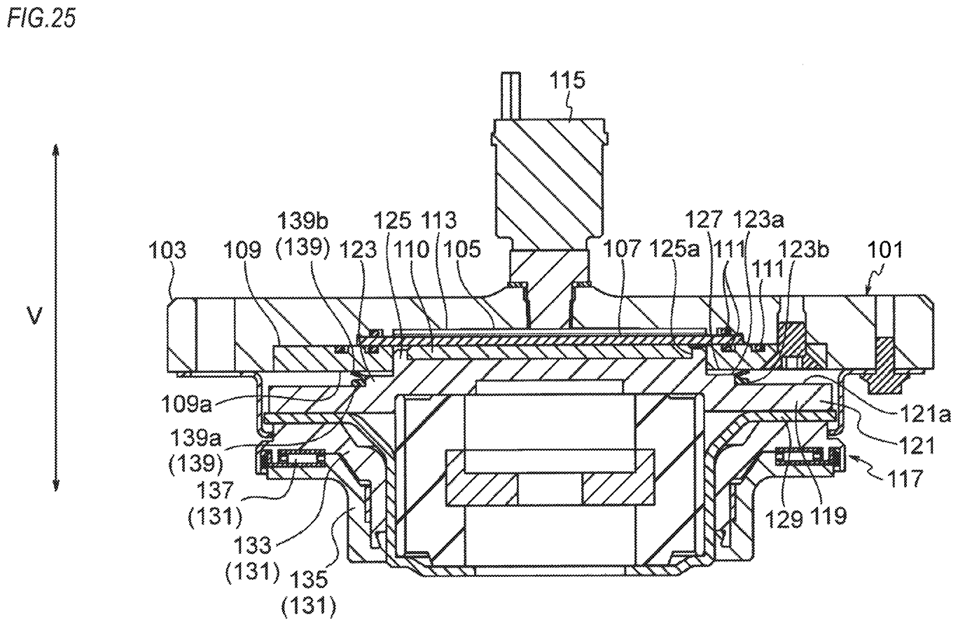

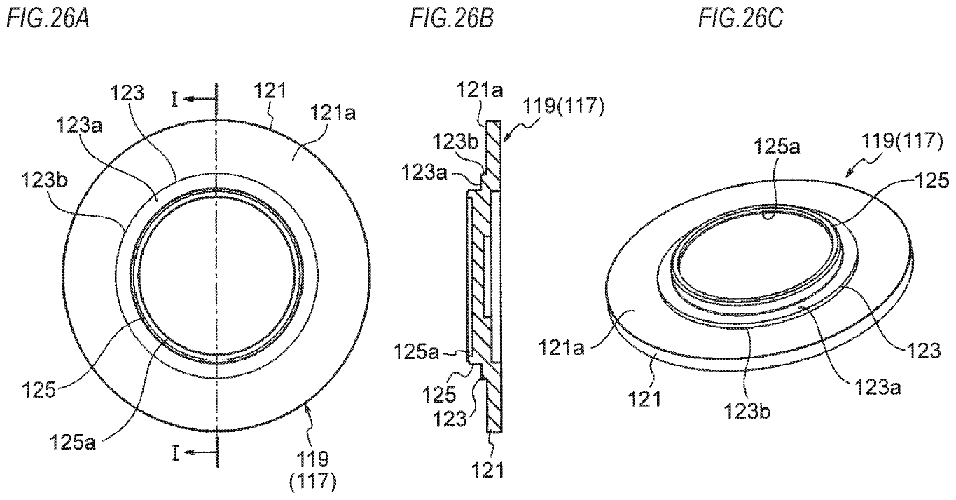

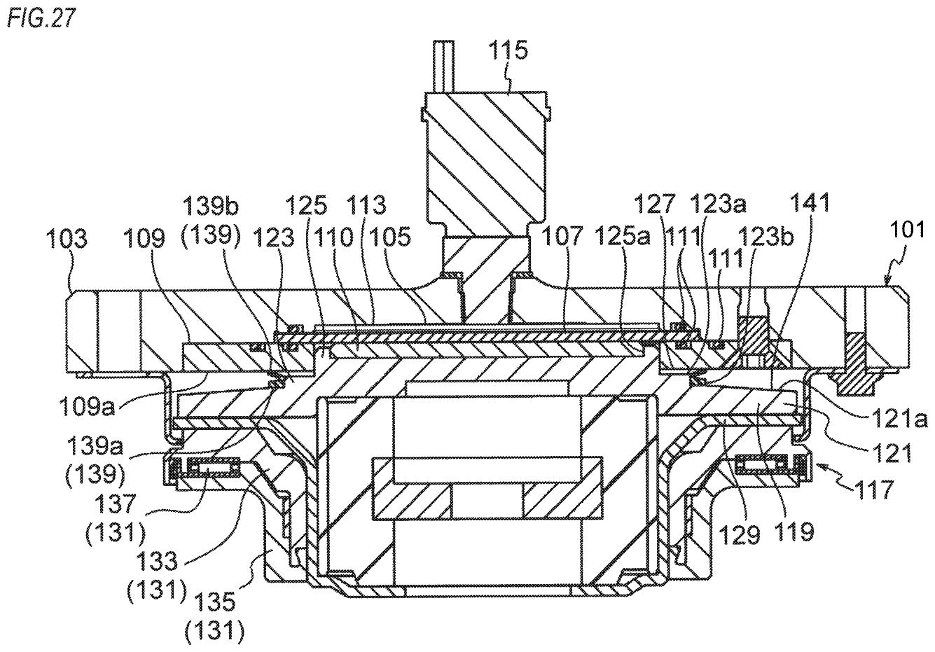

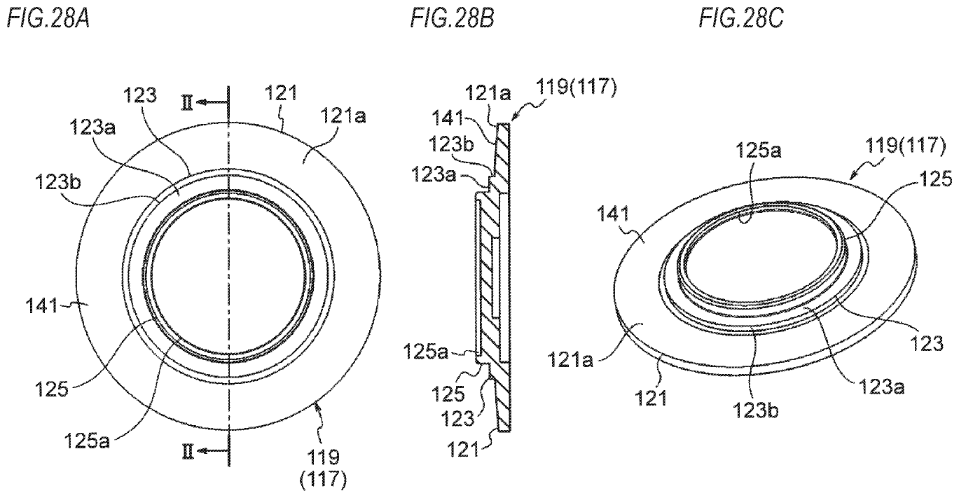

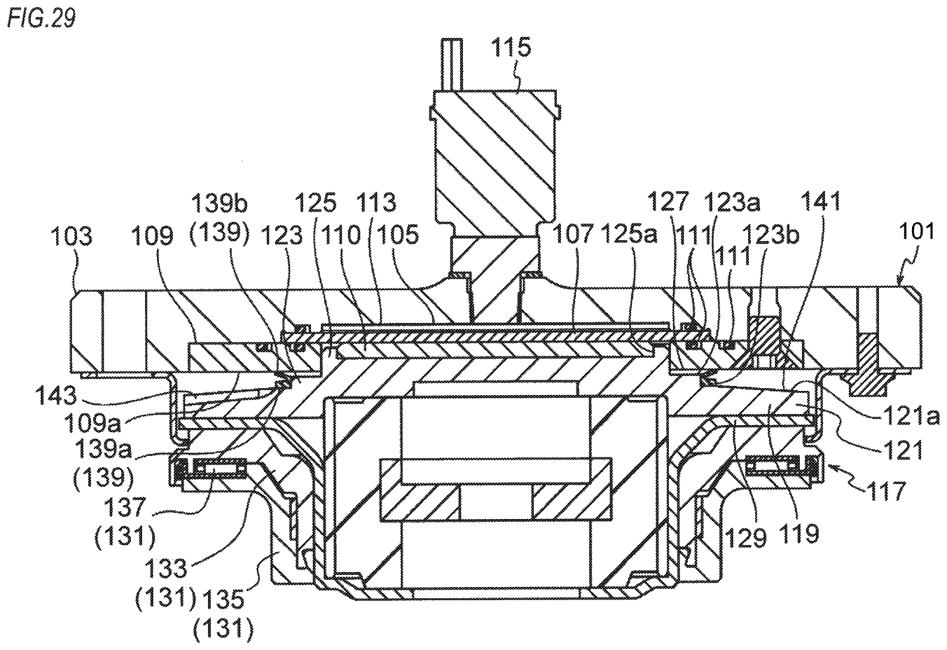

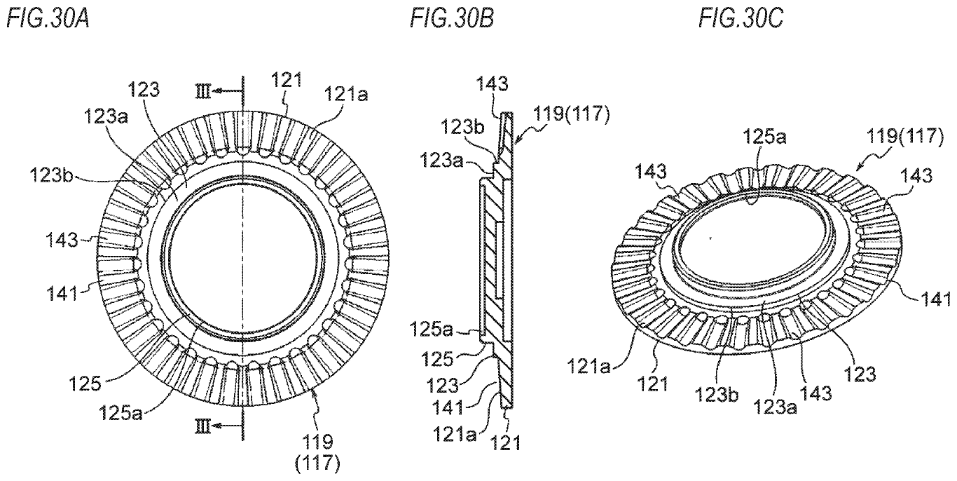

In the below, an embodiment of the vehicle weight measurement device of the present invention is described with reference to the accompanying drawings. FIGS. 25 and 26 depict a twelfth embodiment, FIGS. 27 and 28 depict a thirteenth embodiment, and FIGS. 29 and 30 depict a fourteenth embodiment. In the meantime, the embodiments are just embodiments of the present invention, are not construed as being limited thereto and can be design-changed within the scope of the present invention.

### Twelfth Embodiment

FIGS. 25 and 26 depict a twelfth embodiment. The vehicle weight measurement device of the twelfth embodiment includes a moving body (piston part) 117 configured to move by resilient force of a spring and an attachment body (load detection part) 101 to be attached and fixed to a vehicle. A sealing device 139 configured to prevent introduction of foreign matters into an oil chamber 113 is provided between the moving body 117 and the attachment body 101.

The attachment body 101 includes a top plate 103 that is to be attached and fixed to a vehicle-side, a collar 109 provided on a lower surface of the top plate 103, a diaphragm 107 sandwiched and fixed by the top plate 103 and the collar 109, an oil chamber 113 formed between the top plate 103 and the diaphragm 107 and having a predetermined measurement fluid (operating oil) filled therein, and a pressure sensor 115 provided on an upper surface of the top plate 103 and capable of detecting a pressure change of the measurement fluid filled in the oil chamber 113.

the twelfth embodiment, the top plate 103 has an upper surface to be fixed to a vehicle-side, an opened lower surface and a groove part 105 of which an opening region is covered by the diaphragm 107 to thereby form the oil chamber 113.

Also, in the twelfth embodiment, the collar 109 is formed to have a diameter greater than the opening region of the groove part 105. The collar 109 is configured to sandwich, seal and fix a surface part close to an outer diameter of the diaphragm 107 between the collar and an outermore surface part than the opening region of the groove part 105. A reference sign 11 indicates a seal member (O-ring).

The moving body 117 includes a first piston 19 in contact with the diaphragm 107 and capable of pressing the diaphragm 107 in the vertical direction (a direction shown with the arrow V in the drawings), a second piston 129 in contact with the first piston 119 and capable of pressing the first piston 119 in the vertical direction V, and a bearing device 131 in contact with the second piston 129 and interposed between the second piston and a bush for receiving one end (upper end) of a coil spring of a suspension (not shown).

In the twelfth embodiment, the first piston 119 is in contact with the diaphragm 107 via a pad 110. Also, in the twelfth embodiment, the bearing device 131 is configured by interposing a thrust needle bearing 137 between an upper case 133 and a lower case 135.

The sealing device 139 is provided between the first piston 119 (moving body) and the collar 109 (attachment body).

An upper surface (a surface facing the attachment body) of the first piston 119 is formed to have a stepped shape by a large-diameter cylindrical part 121 in contact with the second piston 129, an intermediate cylindrical part 123 erected vertically continuously from an upper surface of the large-diameter cylindrical part 121 in a cylindrical shape having a diameter smaller than the large-diameter cylindrical part 121, and a cylindrical tip part 125 erected vertically continuously from an upper surface of the intermediate cylindrical part 123 in a cylindrical shape having a diameter smaller than the intermediate cylindrical part 123.

An upper surface of the cylindrical tip part 125 is provided with a recessed pad accommodation part 125a capable of accommodating the pad 110 in a protruding shape

The upper surface of the large-diameter cylindrical part 121 and the upper surface of the intermediate cylindrical part 123 have horizontal surface parts (a first horizontal surface part 121a and a second horizontal surface part 123a) having a flat shape and perpendicular to the vertical direction V, respectively.

An erection height of the cylindrical tip part 125 is set so that a gap 127, in which the first piston 119 can move in the vertical direction V by a predetermined distance, can be formed between a lower surface 109a of the collar 109 and the upper surface (second horizontal surface part 123a) of the intermediate cylindrical part 123. In the meantime, an example in which the upper surface of the intermediate cylindrical part 123 is not flat is also within the scope of the present invention.

As the sealing device 139, in the twelfth embodiment, a circular ring-shaped seal member made of an elastic material such as rubber and resin and having a substantial V-shape, in a cross sectional view, may be exemplified.

For example, the sealing device 139 of the twelfth embodiment has an annular base part 139a fixed to the upper surface (first horizontal surface part 121a) of the large-diameter cylindrical part 121 of the first piston 119 and an annular lip part 139b integrally expanded continuously outward from an inner periphery of the annular base part 139a and to sliding contact the lower surface 109a of the collar 109 with elasticity. The annular base part 139a has substantially the same height (thickness) as the intermediate cylindrical part 123. An inner diameter-side of the annular base part 139a is in close contact with an outer peripheral surface of the intermediate cylindrical part 123.

That is, the sealing device 139 is incorporated between the upper surface (first horizontal surface part 121a) of the large-diameter cylindrical part 121 and the lower surface 109a of the collar 109, and is formed to have a dimension (height) and elasticity by which the annular lip part 139b can follow the movement of the first piston and can always seal the gap 127 within a range in which the first piston 119 can move.

According to the twelfth embodiment, even if the foreign matters such as water are introduced into the moving body 117, the gap 127 is sealed all the time by the sealing device 139 incorporated between the upper surface (first horizontal surface part 121a) of the large-diameter cylindrical part 121 and the lower surface 109a of the collar 109 of the first piston 119. Therefore, it is possible to prevent the foreign matters such as water from being introduced into the attachment body 101, i.e., into the attachment body 101 in which the diaphragm 107, the oil chamber 113 and the like are arranged.

The sealing device 139 is not limited to the twelfth embodiment. For example, although not shown, a structure in which an annular lip part is branched in plural and each annular lip part is in close contact with the lower surface 109a of the collar 109 is also possible, a well-known O-ring is also possible and the design can be changed as appropriate within the scope of the present invention.

Also, a plurality of sealing devices having different diameters may be equipped in parallel within the scope of the present invention.

Also, although not shown, a configuration may be adopted in which a periphery of the upper surface (first horizontal surface part 121a) of the large-diameter cylindrical part 121 is provided with an annular fitting groove to which the annular base part 139a of the sealing device 139 can be fitted. Also, a configuration may be adopted in which a periphery of the lower surface 109a of the collar 109 is provided with a sliding contact groove that the annular lip part 139b can contact in a sliding manner. In this way, the design can be changed as appropriate within the scope of the present invention.

Also, unlike the above embodiment, a configuration may be adopted in which the annular base part 139a is fixed to the lower surface 109a of the collar 109 and the annular lip part 109b is in sliding contact with the upper surface (first horizontal surface part 121a) of the large-diameter cylindrical part 121, which is also within the scope of the present invention.

Meanwhile, in the twelfth embodiment, the first piston 119 has the intermediate cylindrical part 123. However, a configuration in which the intermediate cylindrical part 123 is not provided is also within the scope of the present invention.

### Thirteenth Embodiment

FIGS. 27 and 28 depict a thirteenth embodiment of the present invention. In the thirteenth embodiment, an implementation example is described in which a surface of the first piston 119 facing the attachment body 101 is provided with a tapered surface 141 tapered downward from an arrangement position of the sealing device 139.

In the thirteenth embodiment, the upper surface (first horizontal surface part 121a) of the large-diameter cylindrical part 121, which is a surface facing the attachment body 101, is formed as a tapered surface 141 inclined downward from an inner diameter-side end portion (end portion close to the intermediate cylindrical part 123) to an outer diameter-side end portion. In the meantime, in order to strongly fix the annular base part 139a of the sealing device 139, the inner diameter-side end portion of the upper surface of the large-diameter cylindrical part may be formed with the tapered surface while a flat surface is left.

According to the thirteenth embodiment, even if the foreign matters such as water are introduced into the moving body 117, it is possible to expedite the discharge of the foreign matters such as water by the tapered surface 141 of the first piston 119. Therefore, it is possible to effectively achieve the effects of sealing the gap 127 and preventing the introduction of foreign matters by the sealing device 139.

Since the other configurations and operational effects are the same as the twelfth embodiment, the detailed descriptions are omitted.

### Fourteenth Embodiment

FIGS. 29 and 30 depict a fourteenth embodiment of the present invention. The fourteenth embodiment is an implementation example in which the tapered surface 141 of the first piston 119 disclosed in the thirteenth embodiment is provided with concave grooves 143 inclined downward from the inner diameter-side end portion to the outer diameter-side end portion.

The concave groove 143 is formed from the inner diameter-side end portion to the outer diameter-side end portion of the tapered surface 141 of the first piston 119 in a downward inclined shape more sharply than the tapered surface 141 of the first piston 119.

Also, the concave grooves 143 are provided radially with intervals in a circumferential direction of the upper surface of the large-diameter cylindrical part 121. In the fourteenth embodiment, the plurality of concave grooves 143 is provided in the same shape with constant intervals. However, the present invention is not limited thereto. For example, a plurality of concave grooves having different shapes may be provided, and the arrangement intervals may also be arbitrarily set.

According to the fourteenth embodiment, even if the foreign matters such as water are introduced into the moving body 117, it is possible to expedite the discharge of the foreign matters such as water by the tapered surface 141 of the first piston 119 and the concave grooves 143 provided on the tapered surface 141. Therefore, it is possible to effectively achieve the effects of sealing the gap 127 and preventing the introduction of foreign matters by the sealing device 139.

Since the other configurations and operational effects are the same as the twelfth embodiment and the thirteenth embodiment, the detailed descriptions are omitted.

Also, a configuration in which the first horizontal surface part 121a having a flat shape of the large-diameter cylindrical part 121 of the first piston 119 described in the twelfth embodiment is provided with the concave grooves 143 inclined downward from the inner diameter-side end portion to the outer diameter-side end portion of the large-diameter cylindrical part 121 is also within the scope of the present invention.

The subject application is based on Japanese Patent Application Nos. 2017-231570 filed on Dec. 1, 2017, 2017-225502 filed on Nov. 24, 2017 and 2018-97767 filed on May 22, 2018, the contents of which are incorporated herein by reference.

### INDUSTRIAL APPLICABILITY

The vehicle weight measurement device of the present invention is not limited to the suspension having the configurations described in the embodiments and can be used for a suspension having other configurations. Also, the vehicle weight measurement device of the present invention can be used with being incorporated in the suspension for front wheels or rear wheels. Also, the vehicle, which is an attachment target, is not particularly limited.

Also, the vehicle weight measurement device of the present invention can be used in a field of improving environmental performance (saving fuel consumption) by performing speed change control in accordance with a loaded weight, a field of improving safety by performing brake control, considering a weight distribution, and a field of improving comfortableness by performing control of keeping a steering environment constant.

### REFERENCE SIGNS UST

1: attachment body, 3: bottom plate, 5: groove part, 7: diaphragm, 13: oil chamber, 15: pressure sensor, 17: moving body, 19: piston, 25: stopper ring, 27: fixing part, 29: separation and detachment prevention part, 31: rotation prevention part, 37, 47: pin, 51: sealing mechanism, 101: attachment body, 103: top plate, 105: groove part, 107: diaphragm, 109: collar, 113: oil chamber, 115: pressure sensor, 117: moving body, 119: piston (first piston), 139: sealing device, 141: tapered surface, 143: concave groove

1. A vehicle weight measurement device including:
a moving body configured to move by resilient force of a spring;
an attachment body including at least:
a diaphragm configured to be press-deformable by a movement of the moving body;
an oil chamber having a predetermined measurement fluid filled therein and an internal pressure capable of changing as a result of pressing the diaphragm and;
a pressure sensor capable of detecting a pressure change in the oil chamber;
a stopper ring provided between the moving body and the attachment body; and
a rotation prevention part configured to prevent the moving body and the attachment body from rotating relative to each other,
wherein the stopper ring includes:
a fixing part fixed to one of the moving body and the attachment body; and
a separation and detachment prevention part provided at the other of the moving body and the attachment body and configured to prevent the moving body and the attachment body from separating and detaching, without inhibiting movement of the moving body, and
wherein the rotation prevention part includes a pin fitted from the moving body to the attachment body.

2. The vehicle weight measurement device according to claim 1, wherein
the attachment body includes a bottom plate having a lower surface to be in contact with an arm of a suspension upon installation, an opened upper surface and a groove part of which an opening region is covered by the diaphragm to thereby form the oil chamber, and
the moving body includes a piston provided to be movable in a longitudinal direction of the suspension and capable of pressing the diaphragm by resilient force of a spring of the suspension.

3. The vehicle weight measurement device according to claim 2, wherein
the stopper ring includes:
a cylindrical part configured to cover outer peripheries of the bottom plate and the piston; and
a circular ring part formed to have an inner diameter smaller than an outer diameter of the bottom plate by a lower surface of the cylindrical part,
a part of the cylindrical part is press-fitted and fixed to the outer periphery of the piston and thus functions as the fixing part,
the circular ring part is engaged by the lower surface of the bottom plate without inhibiting movement of the moving body and thus functions as the separation and detachment prevention part configured to prevent the moving body and the attachment body from separating and detaching, and
the rotation prevention part is configured by a first fitting hole provided in the piston, a first notched groove provided in the bottom plate, and a pin capable of being fitted from the first fitting hole to the first notched groove.

4. The vehicle weight measurement device according to claim 2, wherein
the stopper ring includes:
a cylindrical part configured to cover outer peripheries of the bottom plate and the piston; and
a circular ring part formed to have an inner diameter smaller than an outer diameter of the bottom plate by a lower surface of the cylindrical part,
a part of the cylindrical part is press-fitted and fixed to the outer periphery of the piston and thus functions as the fixing part,
the circular ring part is engaged by the lower surface of the bottom plate without inhibiting movement of the moving body and thus functions as the separation and detachment prevention part configured to prevent the moving body and the attachment body from separating and detaching, and
the rotation prevention part is configured by a second notched groove provided in the piston, a second fitting hole provided in the bottom plate, and a pin capable of being fitted from the second notched groove to the second fitting hole.

5. A vehicle weight measurement device including:
a moving body configured to move by resilient force of a spring;
an attachment body including at least:
a diaphragm configured to be press-deformable by a movement of the moving body;
an oil chamber having a predetermined measurement fluid filled therein; and
an internal pressure capable of changing as a result of pressing the diaphragm, and
a pressure sensor capable of detecting a pressure change in the oil chamber;
a stopper ring provided between the moving body and the attachment body, and
a rotation prevention part configured to prevent the moving body and the attachment body from rotating relative to each other,
wherein the stopper ring includes a fixing part fixed to one of the moving body and the attachment body and a separation and detachment prevention part provided at the other of the moving body and the attachment body and configured to prevent the moving body and the attachment body from separating and detaching, without inhibiting movement of the moving body, and
wherein the rotation prevention part includes a pin fitted from one of the moving body and the attachment body, to which the fixing part of the stopper ring is not fixed, to the stopper ring.

6. The vehicle weight measurement device according to claim 1 further including a sealing mechanism configured to prevent foreign matters from being introduced into a movement allowing gap formed between facing surfaces of the moving body and the attachment body.

7. The vehicle weight measurement device according to claim 6, wherein the sealing mechanism is configured by a seal part provided between the stopper ring and the attachment body.

8. The vehicle weight measurement device according to claim 7, wherein the seal part is provided integrally with the stopper ring and is in sliding contact with the attachment body.

9. The vehicle weight measurement device according to claim 7, wherein the seal part is provided integrally with the attachment body and is in sliding contact with the stopper ring.

10. The vehicle weight measurement device according to claim 6, wherein
an elastic plate is provided on an attachment surface-side of the attachment body, and
the sealing mechanism includes a seal part provided on an outer peripheral edge of the elastic plate and being in sliding contact with the stopper ring.

11.-14. (canceled)
